(19) United States
(12) Patent Application Publication
(10) Pub. No.: US 2018/0113055 A1
(43) Pub. Date: Apr. 26, 2018

(54) SUSPENSION VIBRATION INFORMATION ESTIMATION DEVICE

(71) Applicant: KYB Corporation, Tokyo (JP)

(72) Inventor: Tomoo KUBOTA, Tokyo (JP)

(73) Assignee: KYB Corporation, Tokyo (JP)

(21) Appl. No.: 15/558,741

(22) PCT Filed: Mar. 29, 2016
(86) PCT No.: PCT/JP2016/060022

§ 371 Date: Sep. 15, 2017

(30) Foreign Application Priority Data
Mar. 31, 2015 (JP) 2015-073235

(51) Int. Cl. G01M 17/04; B60G 17/019

(52) U.S. Cl. CPC G01M 17/04; B60G 17/01908; B60G 17/01933

(57) ABSTRACT

There is provided a suspension vibration information estimation device capable of accurately estimating suspension vibration information on a rear wheel side. The suspension vibration information estimation device obtains suspension vibration information on a rear wheel side of a vehicle based on rear wheel unsprung vibration information and rear wheel sprung vibration information, estimates the suspension vibration information in consideration of a vibration state of a vehicle body on the rear wheel side, and thus may accurately estimate the suspension vibration information on the rear wheel side.

### TECHNICAL FIELD

The present invention relates to a suspension vibration information, estimation device.

### BACKGROUND ART

In a suspension vibration information estimation device for estimating vibration information of a suspension of a vehicle, for example, as disclosed in JP08-175146A, an estimation control operation is performed such that a delay time until a rear wheel passes the same road surface as a road surface passed by a front wheel is obtained from a velocity and a wheel base length of the vehicle, an unsprung motion velocity at which the front wheel passes the same road surface is estimated to be an unsprung motion velocity of the rear wheel after the delay time, and a damping force output to a damper on the rear wheel side is controlled based on this unsprung motion velocity and an integrated value thereof.

In addition, in a suspension vibration information estimation device disclosed in JP 2009-234454 A; a delay time until a rear wheel passes the same irregular part as an irregular part passed by a front, wheel is obtained, a damping force to be generated in a damper on the rear wheel is obtained from damper displacement and sprung acceleration at the time when the front wheel passes the irregular part, and the damping force is exerted by the damper on the rear wheel side after the delay time from a time at which the front wheel passes the irregular part.

### SUMMARY OF THE INVENTION

However, in a conventional suspension vibration information estimation device, a sum of a differential value of relative displacement between a vehicle and a vehicle wheel on a front wheel side and an integrated value of sprung acceleration is used as an unsprung motion velocity of a rear wheel without change in estimating the unsprung motion velocity of the rear wheel. Thus, information on the rear wheel side is not taken into consideration at all, and suspension vibration information on the rear wheel side may not be accurately estimated.

In addition, in another suspension vibration information estimation device, damper displacement at the time when an irregular part passed by a front wheel is crossed is regarded as damper displacement of a rear wheel without change to obtain a damping force. Thus, in the other suspension vibration information estimation device, information on the rear wheel side is not taken into consideration at all, and suspension vibration information on the rear wheel side may not be accurately estimated.

In this regard, the present invention has been conceived to improve the above-described defect, and an object of the present invention is to provide a suspension vibration information estimation device capable of accurately estimating suspension vibration information on a rear wheel side.

To achieve the object, a suspension vibration information estimation device in solutions of problems of the present invention obtains suspension vibration information on a rear wheel side in a vehicle based on rear wheel unsprung vibration information and rear wheel sprung vibration information, and estimates the suspension vibration information by considering a vibration, state of the vehicle on the rear wheel side. According to the suspension vibration information estimation device of the present invention, it is possible to accurately estimate suspension vibration information on the rear wheel side.

### BRIEF DESCRIPTION OF DRAWINGS

FIG. 1 is a block diagram of a suspension vibration information estimation device according to a first embodiment.

FIG. 2 is a diagram illustrating a gain frequency characteristic of a first integration low pass filter.

FIG. 3 is a diagram illustrating a gain frequency characteristic of a first low frequency removal high pass filter.

FIG. 4 is a diagram illustrating a characteristic obtained by synthesizing the gain frequency characteristics of the first integration low pass filter and the first low frequency removal high pass filter.

FIG. 5 is a diagram illustrating a gain frequency characteristic of a differentiation high pass filter.

FIG. 6 is a diagram illustrating a gain frequency characteristic of a high frequency removal low pass filter.

FIG. 7 is a diagram illustrating a characteristic obtained by synthesizing the gain frequency characteristics of the differentiation high pass filter and the high frequency removal low pass filter.

FIG. 8 is a diagram for description of a state in which a front wheel and a rear wheel of a vehicle pass the same road surface during driving.

FIG. 9 is a configuration diagram of data when a front wheel unsprung velocity is stored.

FIG. 10 is a diagram illustrating a change in front wheel unsprung velocity.

FIG. 11 is a flowchart illustrating a processing procedure in a rear wheel unsprung vibration information estimator.

FIG. 12 is a block diagram of a suspension vibration information estimation device in a modified example of the first embodiment.

FIG. 13 is a diagram in which the suspension vibration information estimation device of the first embodiment is applied to a control device.

FIG. 14 is a diagram illustrating an example of a relationship between a reliability level and a steering angle.

FIG. 15 is a diagram illustrating another example of a relationship between a reliability level and a steering angle.

FIG. 16 is a diagram illustrating a front wheel unsprung velocity and a rear wheel unsprung velocity at the time of velocity change.

FIG. 17(A) is a graph illustrating a velocity difference between the front wheel and the rear wheel with respect to a travel distance during deceleration. FIG. 17(B) is a graph illustrating a velocity ratio of the front wheel and the rear wheel with respect to a travel distance during deceleration.

FIG. 18(A) is a graph illustrating a velocity difference between the front wheel and the rear wheel with respect to a travel distance during deceleration. FIG. 18(B) is a graph illustrating a velocity ratio of the front wheel and the rear wheel with respect to a travel distance during deceleration.

FIG. 19 is a graph illustrating a relationship between a limit velocity and an acceleration/deceleration rate.

FIG. 20 is a graph illustrating a relationship between a squared value of the limit velocity and the acceleration/deceleration rate.

FIG. 21 is an example of a map illustrating a relationship between a reliability level gain and a reliability level.

FIG. 22 is another example of a map illustrating a relationship between a reliability level gain and a reliability level.

FIG. 23 is a flowchart illustrating a processing procedure of the suspension vibration information estimation device.

FIG. 24 is a block diagram illustrating a suspension vibration information estimation device according to a second embodiment.

FIG. 25 is a block diagram illustrating a suspension vibration information estimation device according to a third embodiment.

### DESCRIPTION OF EMBODIMENTS

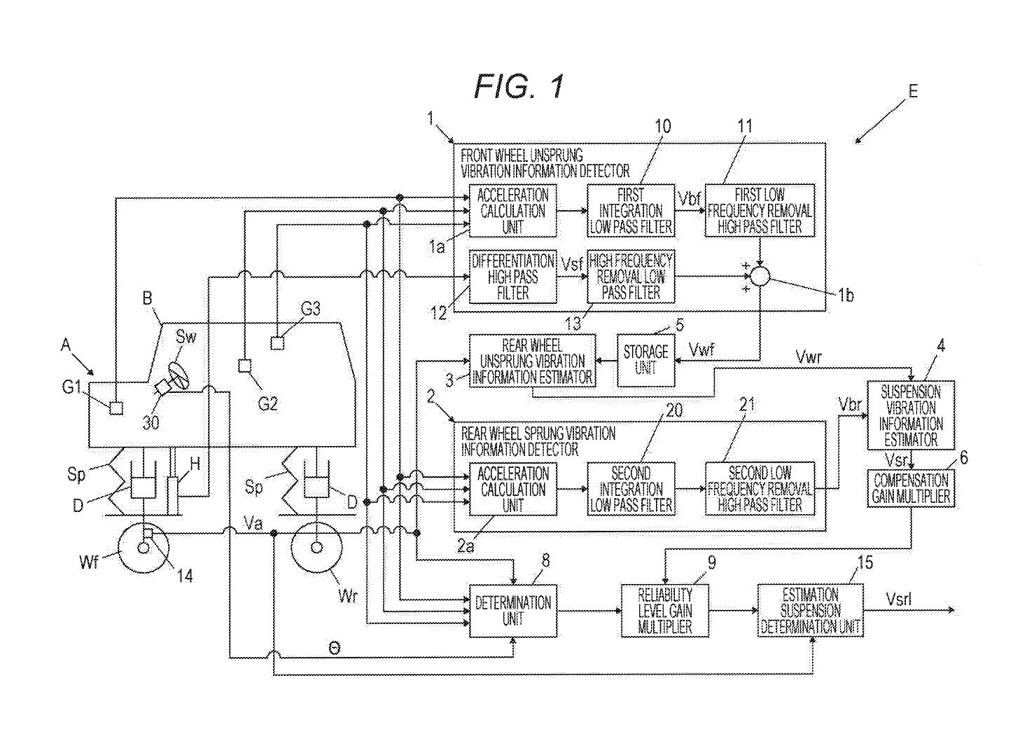

Hereinafter, the present invention will be described based on embodiments illustrated in drawings. As illustrated in FIG. 1, a suspension vibration information estimation device E includes a front wheel unsprung vibration information detector 1 that obtains front wheel unsprung vibration information corresponding to unsprung vibration information on a front wheel Wf side in a vehicle A, a rear wheel sprung vibration information detector 2 that obtains rear wheel sprung vibration information corresponding to sprung vibration information on a rear wheel Wr side in the vehicle A, a rear wheel unsprung vibration information estimator 3 that estimates unsprung vibration information on the rear wheel side of the vehicle A, and a suspension vibration information estimator 4 that obtains suspension vibration information on the rear wheel Wr side in the vehicle A based on rear wheel unsprung vibration information and the rear wheel sprung vibration information, and obtains the suspension vibration information on the rear wheel Wr side using information on the front wheel Wf side on the assumption that the rear wheel Wr disposed on the rear side of the front wheel Wf in a front-rear direction of the vehicle A passes the same road surface as a road surface passed by the front wheel Wf in the vehicle A. A sprung member in the vehicle A corresponds to a vehicle body B, and information that allows vibration to be identified such as displacement, velocity, acceleration, etc. of the vehicle body B corresponds to the sprung vibration information. In addition, an unsprung member in the vehicle A corresponds to the front wheel Wf and the rear wheel Wr, information that allows vibration to be identified such as displacement, velocity, acceleration, etc. of the front wheel Wf corresponds to the front wheel unsprung vibration information, and information that allows vibration to be identified such as displacement, velocity, acceleration, etc. of the rear wheel Wr corresponds to the rear wheel unsprung vibration information.

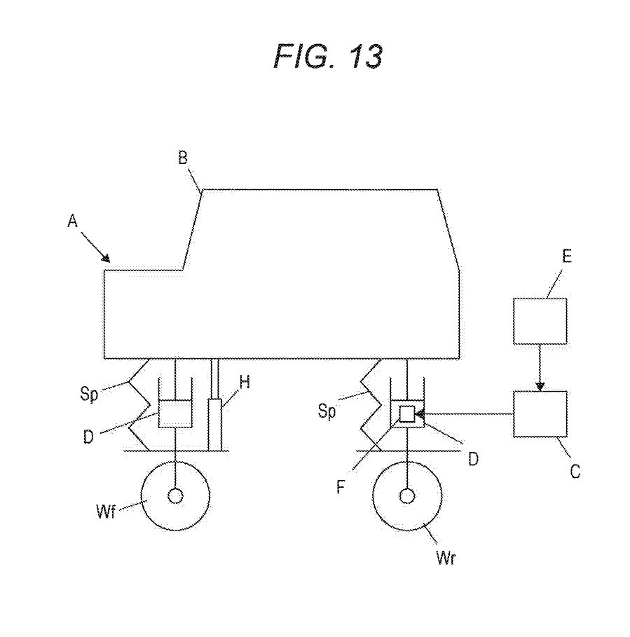

For example, the suspension vibration information obtained by the suspension vibration information estimation device E is used by a control device C as information at the time of determining a damping force generated by a damper D interposed between the vehicle body B and the rear wheel Wr of the vehicle A as illustrated in FIG. 13 or a control force generated by an actuator (not illustrated). In addition, the vehicle A includes a suspension spring Sp and the damper D interposed between the vehicle body B and the front wheel Wf and between the vehicle body B and the rear wheel Wr, and the vehicle body B is elastically supported by the suspension spring Sp. The damper D includes a damping force adjuster F therein, and the control device C outputs a control command to the damping force adjuster F. In this way, a damping force of the damper D is controlled in accordance with a control force determined by the control device C.

Hereinafter, each unit of the suspension vibration information estimation device E will be described in detail. In the suspension vibration information estimation device E of the present embodiment, as illustrated in FIG. 1, the front wheel unsprung vibration information detector 1 detects a front wheel unsprung velocity Vwf corresponding to a velocity of the front wheel Wf in a vertical direction as the front wheel unsprung vibration information. In this example, the front wheel unsprung vibration information detector 1 detects a front wheel sprung velocity Vbf serving as front wheel sprung vibration information and a suspension velocity Vsf corresponding to a relative velocity of the vehicle body B and the front wheel Wf in the vertical direction, and detects the front wheel unsprung velocity Vwf by adding the suspension velocity Vsf to the front wheel sprung velocity Vbf.

When, the front wheel sprung velocity Vbf is detected, the front wheel unsprung vibration information detector 1 obtains the front wheel sprung velocity Vbf from accelerations of the vehicle body B in the vertical direction detected by three acceleration sensors G1, G2, and G3 disposed in the vehicle body B so as not to lie on the same straight line on the same horizontal plane. When the vehicle body B is regarded as a rigid body, and vertical accelerations are obtained at three arbitrary positions not on the same straight line on the same horizontal plane of the vehicle foody B, vertical acceleration at an arbitrary position of the vehicle body B may be obtained. For this reason, the front wheel unsprung vibration information detector 1 includes an acceleration calculation unit 1a, obtains vertical acceleration, immediately above the front wheel Wf using the acceleration calculation unit 1a, and detects the front wheel sprung velocity Vbf by integrating the obtained vertical acceleration immediately above the front wheel. Vertical acceleration of the vehicle body B may be detected by providing an acceleration sensor immediately above the front wheel Wf of the vehicle body B instead of the acceleration sensors G1, G2, and G3. In addition, as described below, when vertical acceleration immediately above the rear wheel Wr in the vehicle body B needs to be detected by the rear wheel sprung vibration information detector 2, and accelerations of the vehicle body B immediately above all four wheels corresponding to the front and rear wheel s Wf and Wr of the four-wheeled vehicle are detected by acceleration sensors, four acceleration sensors are needed. Thus, it is advantageous to detect accelerations using the three acceleration sensors G1, G2, and G3 as described above in that cost corresponding to one sensor may be reduced, which does not exclude using four acceleration sensors.

The front wheel unsprung vibration information detector 1 includes a stroke sensor H to detect the suspension velocity Vsf. Although not illustrated, the stroke sensor H may directly detect relative displacement between the front wheel Wf and the vehicle body B, or detect quantify of state that can be converted into relative displacement between the front wheel Wf and the vehicle body B. Therefore, the stroke sensor H may detect a swing angle of a suspension arm connecting the front wheel Wf to the vehicle body B with respect to the vehicle body B.

The damper D is connected to the vehicle body B through amount (not illustrated) including vibration isolation rubber, and is connected to the front wheel Wf through a bush (not illustrated). However, since an influence of deformation of the mount or the bush is minor, stroke displacement of the damper D may be detected to regard the stroke displacement as vertical relative displacement between the vehicle body B and the front wheel Wf corresponding to displacement of the suspension. Therefore, the stroke sensor H may be integrally incorporated in the damper D interposed between the vehicle body B and the front wheel Wf.

Further, the front wheel unsprung vibration information detector 1 detects the suspension velocity Vsf by differentiating the vertical relative displacement between the vehicle body B and the front wheel Wf detected by the stroke sensor H.

The front wheel unsprung vibration information detector 1 includes an adder 1b, and obtains the front wheel unsprung velocity Vwf by adding the front wheel sprung velocity Vbf and the suspension velocity Vsf obtained as described above using the adder 1b. Incidentally, in the present embodiment, the front wheel unsprung vibration information detector 1 obtains acceleration immediately above the front wheel Wf from accelerations detected by the acceleration sensors G1, G2, and G3 through calculation, and obtains the front wheel sprung velocity Vbf by integrating the acceleration. In addition, the suspension velocity Vsf is obtained by differentiating the relative displacement between the vehicle body B and the front wheel Wf detected by the stroke sensor H. The front wheel unsprung velocity Vwf may be obtained by adding the front wheel sprung velocity Vbf and the suspension velocity Vsf obtained in this way without change. The suspension velocity Vsf is detected including a lever ratio at a suspension of the front wheel Wf. For example, when the stroke sensor H detects displacement of the vehicle body B and the suspension arm supporting the front wheel Wf, actual relative displacement between the vehicle body B and the front wheel Wf is different from a stroke amount detected by the stroke sensor H. However, a lever ratio taking an attachment position of the stroke sensor H on the arm and an arm length into account may be used as gain and multiplied by the stroke amount output by the stroke sensor H. In addition, when the front wheel Wf vibrates, the vehicle body B inevitably vibrates. Further, a coupled vibration component is superimposed on the front wheel unsprung velocity Vwf and the front wheel sprung velocity Vbf. Furthermore, a lever ratio of the suspension of the front wheel Wf is set. In the case of obtaining the suspension velocity Vsf by subtracting the front wheel sprung velocity Vbf from the front wheel unsprung velocity Vwf, when a value obtained by subtracting the front wheel sprung velocity Vbf from the front wheel unsprung velocity Vwf is used as the suspension velocity Vsf on the front wheel side without change, an error that may not be overlooked occurs between the suspension velocity Vsf and an actual suspension velocity in some cases due to an influence of the coupled vibration component and the lever ratio described above. In such a case, the influence of the coupled vibration component and the lever ratio may be eliminated by providing a compensation gain multiplier (not illustrated) that multiplies compensation gain by the obtained suspension velocity Vsf. In this way, the suspension velocity Vsf may be accurately conformed to the actual suspension velocity.

In addition, since a tire warps, a component proportional to the front wheel sprung velocity Vbf is superimposed on the front wheel unsprung velocity Vwf of the front wheel Wf due to warping of the tire in addition to the lever ratio. Further, a component proportional to the front wheel unsprung velocity Vwf is superimposed on the front wheel sprung velocity Vbf. Specifically, a velocity component of a value obtained by multiplying the front wheel sprung velocity Vbf by a spring constant ratio, which is obtained by dividing a spring constant of the suspension spring Sp by a spring constant of the tire, is superimposed on the front wheel unsprung velocity Vwf. Therefore, when a velocity component resulting from warping of the tire is eliminated at the time of calculating the suspension velocity Vsf, the suspension velocity Vsf may be more accurately conformed to the actual suspension velocity. The lever ratio may be taken into consideration when the velocity component resulting from warping of the tire is eliminated. For example, the spring constant ratio taking the lever ratio into consideration may be considered as one gain, and a velocity component to be eliminated from the suspension velocity Vsf may be calculated by multiplying the front wheel sprung velocity Vbf by the gain. In addition, when warping of the tire is taken into consideration in addition to the lever ratio, a suspension velocity Vsr on the rear wheel side estimated by the suspension vibration information estimator 4 described below may be more accurately conformed to an actual suspension velocity.

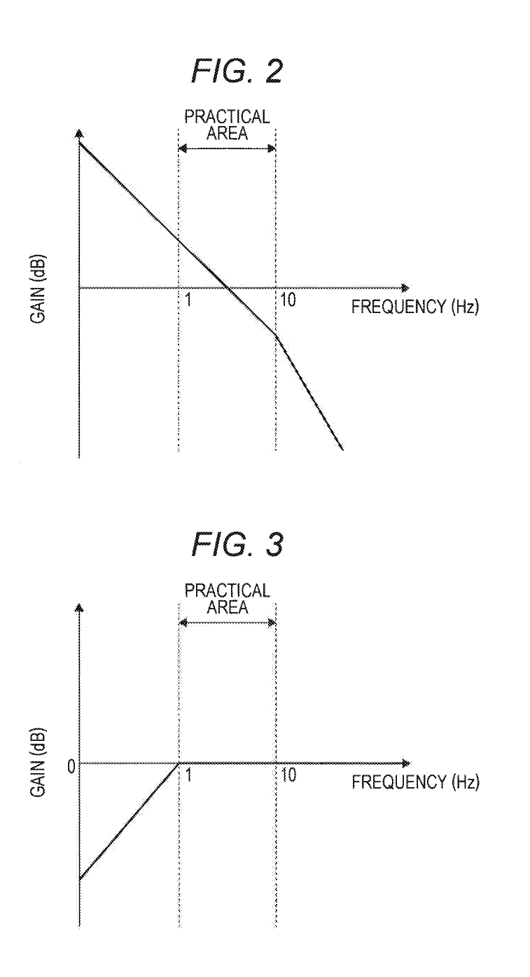

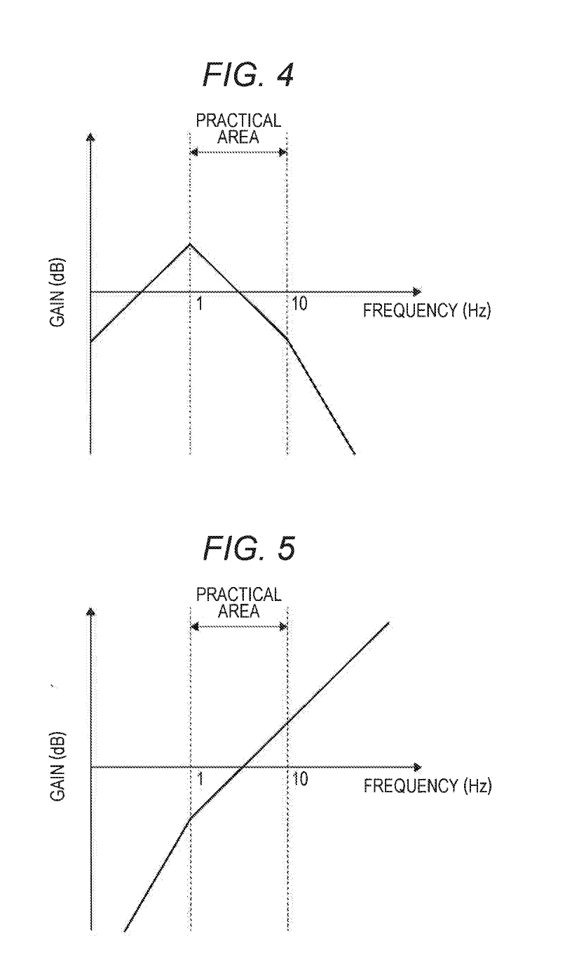

Since the front wheel sprung velocity Vbf is obtained by integrating acceleration immediately above the front wheel Wf, the front wheel unsprung vibration information detector 1 includes a first integration low pass filter 10 that integrates the vertical acceleration immediately above the front wheel Wf obtained by the acceleration calculation unit 1a. As illustrated in FIG. 2, the first integration low pass filter 10 has a characteristic in which a decline in gain with respect to an increase in frequency increases beyond a practical area of the suspension of the vehicle, in general, a frequency domain of 1 Hz to 10-odd Hz. A value corresponding to an integrated value of the acceleration may be obtained by filtering the acceleration using the first integration low pass filter 10. Therefore, the front wheel sprung velocity Vbf may be obtained by filtering the acceleration using the first integration low pass filter 10. As described above, when acceleration is integrated using the first integration low pass filter 10, an integral drift of a low frequency becomes an issue. The front wheel unsprung vibration information detector 1 includes a first low frequency removal high pass filter 11 to remove an integral drift from the front wheel sprung velocity Vbf obtained by processing in the first integration low pass filter 10, and the front wheel sprung velocity Vbf is filtered by the first low frequency removal high pass filter 11 to remove a low frequency component, thereby obtaining the front wheel sprung velocity Vbf from which the integral drift is removed. As illustrated in FIG. 3, a cutoff frequency of the first low frequency removal high pass filter 11 is in a lower frequency range than a sprung resonance frequency, so that a sprung resonance frequency component is not removed from the front wheel sprung velocity Vbf. When gain frequency characteristics of the first integration low pass filter 10 and the first low frequency removal high pass filter 11 are synthesized, a characteristic illustrated in FIG. 4 is obtained. The acceleration may be filtered by the first low frequency removal high pass filter 11 before the first integration low pass filter 10, and an order of processing may be arbitrarily changed. In addition, the front wheel unsprung vibration information detector 1 may not separately include the first integration low pass filter 10 and the first low frequency removal high pass filter 11. Instead, the front wheel unsprung vibration information detector 1 may include a single band pass filter having the characteristic illustrated in FIG. 4 obtained by synthesizing the characteristics of the first integration low pass filter 10 and the first low frequency removal high pass filter 11, and perform processing using this band pass filter.

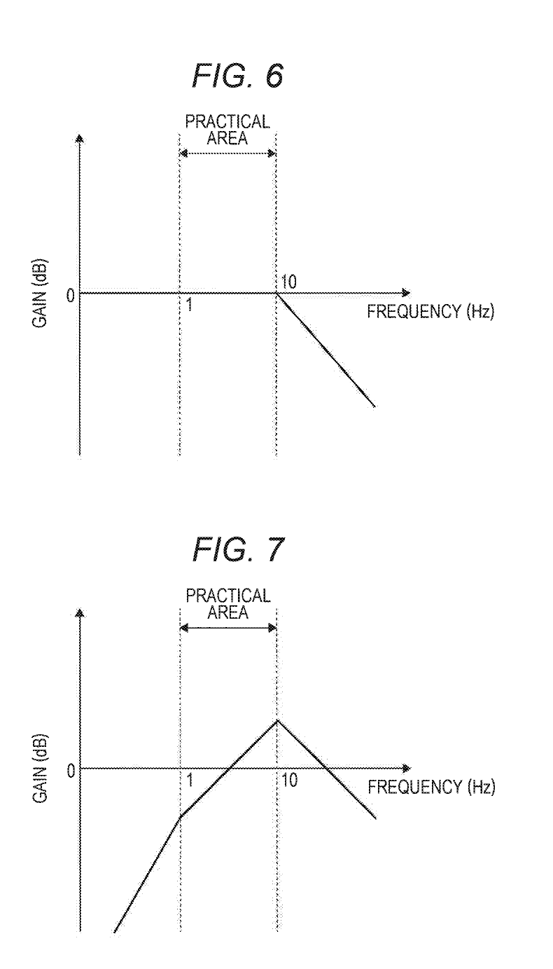

Since the suspension velocity Vsf is obtained by differentiating the relative displacement between the vehicle body B and the front wheel Wf detected by the stroke sensor H, the front wheel unsprung vibration information detector 1 includes a differentiation high pass filter 12. As illustrated in FIG. 5, the differentiation high pass filter 12 has a characteristic in which a rise in gain with respect to an increase in frequency increases in a frequency band below a practical area of the suspension of the vehicle, in general, a frequency band of 1 Hz to 10-odd Hz. When the relative displacement is filtered by the differentiation high pass filter 12, a value corresponding to a differential value of the relative displacement is obtained. Therefore, the front wheel unsprung vibration information detector 1 obtains the suspension velocity Vsf by filtering the relative displacement using the differentiation high pass filter 12. When the relative displacement is differentiated using the differentiation high pass filter 12 as described above, there is a problem that differential noise of a high frequency is superimposed on information after differentiation. The front wheel unsprung vibration information detector 1 includes a high frequency removal low pass filter 13 to cancel differential noise from the suspension velocity Vsf obtained by processing in the differentiation high pass filter 12, and removes a high frequency component by filtering the suspension velocity Vsf using the high frequency removal low pass filter 13 to obtain the suspension velocity Vsf from which the differential noise is canceled. As illustrated in FIG. 6, a cutoff frequency of the high frequency removal low pass filter 13 is in a higher frequency range than an unsprung resonance frequency, so that an unsprung resonance frequency component is not removed from the suspension velocity Vsf. When gain frequency characteristics of the differentiation high pass filter 12 and the high frequency removal low pass filter 13 are synthesized, a characteristic illustrated in FIG. 7 is obtained. The relative displacement may be filtered by the high frequency removal low pass filter 13 before the differentiation high pass filter 12, and an order of processing may be arbitrarily changed. In addition, the front wheel unsprung vibration information detector 1 may not separately include the differentiation high pass filter 12 and the high frequency removal low pass filter 13. Instead, the front wheel unsprung vibration information detector 1 may include a single band pass filter having the characteristic illustrated in FIG. 7 obtained by synthesizing the characteristics of the differentiation high pass filter 12 and the high frequency removal low pass filter 13, and perform processing using this band pass filter.

Here, when a conformity degree of sprung vibration components included in the front wheel sprung velocity Vbf and the suspension velocity Vsf is high, a sprung resonance frequency component included in the suspension velocity Vsf is accurately canceled out by addition of the front wheel sprung velocity Vbf and the suspension velocity Vsf. On the other hand, when the conformity degree of the sprung vibration components included in the front wheel sprung velocity Vbf and the suspension velocity Vsf is low, sprung resonance frequency components thereof are not canceled out and remain in the obtained front wheel unsprung velocity Vwf as an error.

Therefore, a conformity degree of sprung vibration components included in the front wheel sprung velocity Vbf obtained by processing in the first integration low pass filter 10 and the first, low frequency removal high pass filter 11 and the suspension velocity Vsf obtained by processing in the differentiation high pass filter 12 and the high frequency removal low pass filter 13 may be high in the practical area, in general, in the frequency band of 1 Hz to 10-odd Hz in the case of the vehicle.

As described above, the acceleration immediately above the front wheel Wf is processed by the first integration low pass filter 10 and the first low frequency removal high pass filter 11, and the relative displacement between the vehicle body B and the front wheel Wf is processed by the differentiation high pass filter 12 and the high frequency removal low pass filter 13. Further, both information items are processed by a high pass filter and a low pass filter. Thus, accuracy of the front wheel unsprung velocity Vwf obtained from the both information items is improved by increasing a conformity degree of gain characteristics of the both information items after processing in the practical area.

When an integral drift is not a problem, the first low frequency removal high pass filter 11 may be removed. In addition, when differential noise is not a problem, the high frequency removal low pass filter 13 may be removed. An integral of the acceleration immediately above the front wheel Wf may be obtained by integral calculation without depending on the first integration low pass filter 10, and differentiation of the relative displacement between the vehicle body B and the front wheel Wf may be obtained by differential calculation without depending on the differentiation high pass filter 12.

Further, when the characteristic obtained by synthesizing the characteristics of the first integration low pass filter 10 and the first low frequency removal high pass filter 11 is conformed to the characteristic obtained by synthesizing the characteristics of the differentiation high pass filter 12 and the high frequency removal low pass filter 13, it is possible to conform gains of the front wheel sprung velocity Vbf and the suspension velocity Vsf to each other and mitigate a phase shift therebetween, and it is possible to accurately detect the front wheel unsprung velocity Vwf by effectively removing the sprung resonance frequency component from the obtained front wheel unsprung velocity Vwf.

In the above description, the front wheel unsprung velocity Vwf is obtained by adding the front wheel sprung velocity Vbf and the suspension velocity Vsf. However, depending on the scheme of assigning signs to the front wheel sprung velocity Vbf and the suspension velocity Vsf, the front wheel unsprung velocity Vwf may be obtained by subtracting the suspension velocity Vsf from the front wheel sprung velocity Vbf or by subtracting the front wheel sprung velocity Vbf from the suspension velocity Vsf.

The front wheel unsprung vibration information detector 1 continuously detects the front wheel unsprung velocity Vwf at every predetermined sampling period as described above, and records the obtained front wheel unsprung velocity Vwf in a storage unit 5. The storage unit 5 may store data and continuously stores the front wheel unsprung velocity Vwf. In addition, when a data amount of the front wheel unsprung velocity Vwf reaches a storage capacity of the storage unit 5, or a predetermined number of data items are accumulated, the storage unit 5 overwrites old data with new data of the front wheel unsprung velocity Vwf in order from the oldest data, thereby storing the front wheel unsprung velocity Vwf while updating the data.

In the suspension vibration information estimation device E of the present embodiment, as illustrated in FIG. 1, the rear wheel unsprung vibration information estimator 3 estimates the rear wheel unsprung velocity Vwr as unsprung vibration information on the rear wheel Wr side of the vehicle A based on the front wheel unsprung velocity Vwf as front wheel unsprung vibration information detected by the front wheel unsprung vibration information detector 1, a velocity Va of the vehicle A in the front-rear direction, and a wheel base length L of the vehicle A. The velocity Va of the vehicle A is detected by a velocity sensor 14 installed in the vehicle A and input to the rear wheel unsprung vibration information estimator 3.

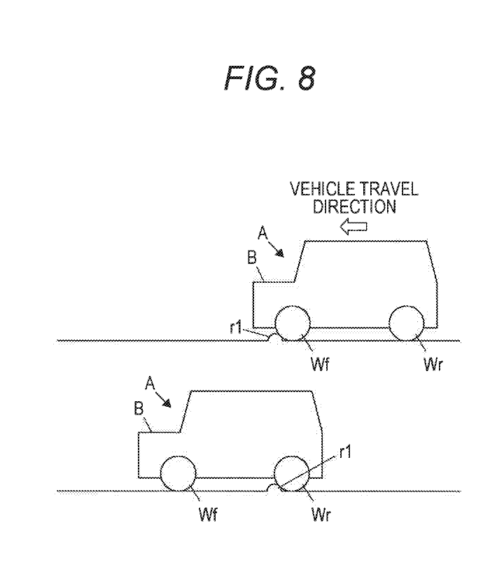

Specifically, the rear wheel unsprung vibration information estimator 3 estimates the rear wheel unsprung velocity Vwr on the assumption that the rear wheel Wr of the vehicle A passes the same road surface as a road surface passed by the front wheel Wf of the vehicle A. As illustrated in FIG. 8, when the front wheel Wf arrives at a certain spot on a road surface r1 as in an upper view of FIG. 8 while the vehicle A is driven, and then the vehicle A moves straight after the spot is passed, the rear wheel Wr provided on a rear side of the front wheel Wf on the same line as the front wheel Wf along the front-rear direction of the vehicle A passes the same road surface r1 as the road surface passed by the front wheel Wf after a few seconds as in a lower view of FIG. 8. In a case where the velocity Va of the vehicle A is constant, when the wheel base length L corresponding to a distance between the front wheel Wf and the rear wheel Wr of the vehicle A is known, a time from when the front wheel Wf passes the road surface r1 until the rear wheel Wr arrives at the road surface r1 may be obtained by calculating L/Va. When the velocity Va of the vehicle A changes after the front wheel Wf passes the road surface r1, the velocity Va is be monitored, and a time at which an integrated value of the velocity Va after the front wheel Wf passes the road surface r1 equals the wheel base length L corresponds to a time at which the rear wheel Wr arrives at the same road surface r1. The above presumption allows to known the number of seconds before which the front wheel Wf passes the road surface r1 from the time at which the rear wheel Wr arrives at the road surface r1. Further, since it is predicted that the rear wheel Wr at the time of passing the road, surface r1 will exhibit the same movement as that of the front wheel Wf at the time when the front wheel Wf passes the road surface r1, the front wheel unsprung velocity Vwf at the time when the front wheel Wf passes the road surface r1 may be estimated to be the rear wheel unsprung velocity Vwr at the time when the rear wheel Wr passes the road surface r1. When the vehicle A is turning or the vehicle A turns after the front wheel Wf passes the road surface r1, and thus a steering angle of a steering wheel of the vehicle A is small, and the rear wheel Wr passes the road surface r1, the front wheel unsprung velocity Vwf after the front wheel Wf passes may be similarly estimated to be the rear wheel unsprung velocity Vwr at the time when the rear wheel Wr passes the road, surface r1.

As described above, the rear wheel unsprung vibration information estimator 3 obtains a time T from a time at which the front wheel Wf passes the road surface r1 until a time at which the rear wheel Wr is considered to pass the road surface r1 based on the velocity Va and the wheel base length L of the vehicle A. Then, at a time when the rear wheel Wr is considered to pass the road surface r1, the rear wheel unsprung vibration information estimator 3 may estimate the front wheel unsprung velocity Vwf obtained the time T ago to be the rear wheel unsprung velocity Vwr at a time when the rear wheel Wr passes the road surface r1. Specifically, the rear wheel unsprung vibration information estimator 3 obtains the time T from the wheel base length L and the velocity Va as velocity information in the front-rear direction of the vehicle A, reads the front wheel unsprung velocity Vwf obtained the time T before a time at which the rear wheel unsprung velocity Vwr is estimated from the storage unit 5, and uses the read front wheel unsprung velocity Vwf as the rear wheel unsprung velocity Vwr. In a case where the rear wheel unsprung vibration information estimator 3 obtains the time T, and the front wheel unsprung velocity Vwf obtained the time T ago is used as the rear wheel unsprung velocity Vwr as described above, when the storage unit 5 stores the front wheel unsprung velocity Vwf, the storage unit 5 may store the front wheel unsprung velocity Vwf by associating a time at which the front wheel unsprung velocity Vwf is detected with the front wheel unsprung velocity Vwf, When a time the time T before the time at which the rear wheel unsprung velocity Vwr is estimated is set to a time t, the front wheel unsprung velocity Vwf obtained exactly at the time t may not be present in the storage unit 5 in some cases. In such a case, the rear wheel unsprung vibration information estimator 3 may estimate the front wheel unsprung velocity Vwf obtained at the time t by performing linear interpolation on two front wheel unsprung velocities Vwf obtained at a time closest to the time t and a time second closest thereto, and use the estimated front wheel unsprung velocity Vwf as the rear wheel unsprung velocity Vwr.

As described above, the rear wheel unsprung vibration information estimator 3 may obtain the time T and use the front wheel unsprung velocity Vwf obtained at the time t as the rear wheel unsprung velocity Vwr. In addition, instead of obtaining the time T, the rear wheel unsprung vibration information estimator 3 may associate a travel distance with the front wheel unsprung velocity Vwf in the storage unit 5, thereby extracting data of the front wheel unsprung velocity Vwf to be used as the rear wheel unsprung velocity Vwr without obtaining the time T. For example, a scheme of extracting data of the front wheel unsprung velocity Vwf without obtaining the time T will be described using a case in which the number of data items stored in the storage unit 5 is set to eight as an example.

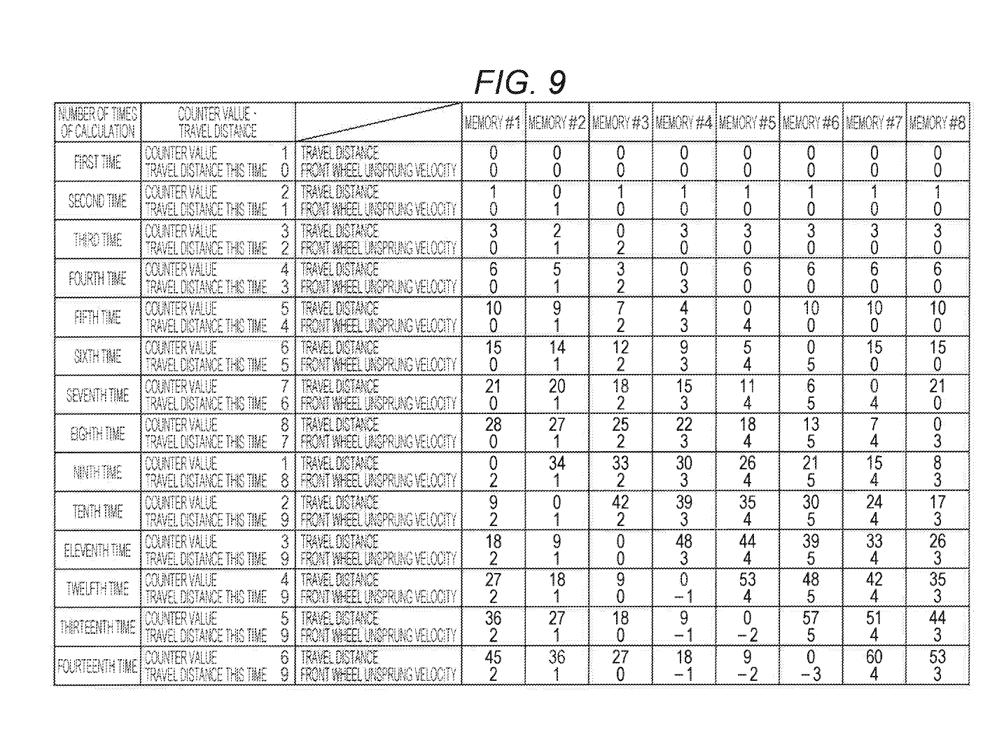

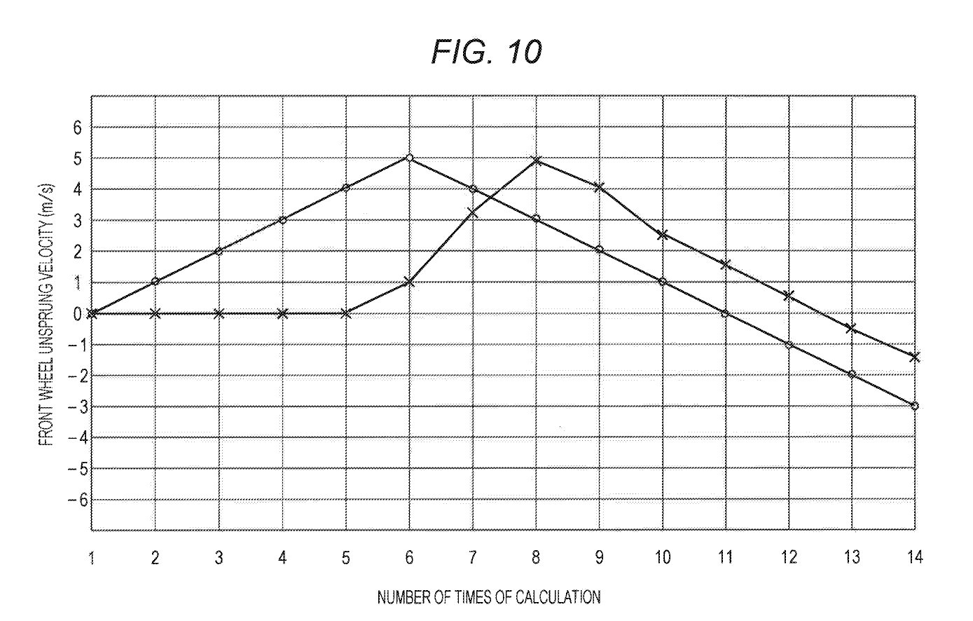

The front wheel unsprung vibration information detector 1 detects the front wheel unsprung velocity Vwf at a predetermined sampling period, and FIG. 9 illustrates a state in which data in memories corresponding to eight storage areas from #1 to #8 provided in the storage unit 5 is updated each time the front wheel unsprung velocity Vwf is detected. More specifically, FIG. 9 illustrates a data state in a case where front wheel unsprung velocities Vwf obtained when front wheel unsprung velocities Vwf detected by the front wheel unsprung vibration information detector 1 change as illustrated in FIG. 10 are successively recorded in the storage unit 5. FIG. 10 is a graph plotting data obtained by detecting the front wheel unsprung velocity Vwf 14 times when the vehicle A starts traveling and accelerates. In FIG. 10, a value of the front wheel unsprung velocity Vwf is a virtual value set to a different value from a value obtained in an actual vehicle, so that the data state of FIG. 9 may be easily understood. In addition, in FIG. 10, detected data is plotted in a black circle, and the estimated rear wheel unsprung velocity Vwr is plotted in an X mark.

In the storage unit 5, the front wheel unsprung velocities Vwf are associated with travel distances and recorded in the memories #1 to #8 provided in the storage areas in the storage unit 5 in order of detection. The rear wheel unsprung vibration information estimator 3 increments a counter value each time recording is performed, and stores a front wheel unsprung velocity Vwf and a travel distance in a memory corresponding to the same number as the counter value at the time of recording the front wheel unsprung velocity Vwf and the travel distance in the storage unit 5. In the case of this embodiment, since eight memories from #1 to #8 are present, when the counter value is incremented from 1 in order and becomes 9, the counter value is reset and rewritten to 1. Therefore, when a front wheel unsprung velocity Vwf and a travel distance are stored in the memory #8, the counter value is reset, and thus the counter value is 1 at the time of storing a front wheel unsprung velocity Vwf and a travel distance next time. Therefore, the rear wheel unsprung vibration information estimator 3 records information thereof in the memory #1.

Since a front wheel unsprung velocity Vwf detected for a first time is 0 as illustrated in FIG. 10, a value of the front wheel unsprung velocity Vwf is recorded as 0 in the memory #1 of the storage unit 5. In addition, a travel distance at a time when the value of the front wheel unsprung velocity Vwf recorded in the memory #1 is obtained is associated with the memory #1, and thus the travel distance becomes 0, and 0 is input to the travel distance of the memory #1. Similarly to the value of the front wheel unsprung velocity Vwf, the travel distance is a virtual value set to a different value from a value obtained in an actual vehicle, so that the data state of FIG. 9 may be easily understood.

When a front wheel unsprung velocity Vwf is detected at a second time, the second front wheel unsprung velocity Vwf is stored in the memory #2. Since a value of the second front wheel unsprung velocity Vwf is 1, the front wheel unsprung velocity Vwf is recorded as 1 in the memory #2. Since a travel distance at a time when the value of the front wheel unsprung velocity Vwf recorded in the memory #2 is obtained is associated with the memory #2, the travel distance recorded in the memory #2 is 0, and thus 0 is input. On the other hand, a value obtained by adding a value of a distance in which the vehicle A travels from a time when the first front wheel unsprung velocity Vwf is detected until a time when the second front wheel unsprung velocity Vwf is obtained to a value of a travel distance up to a previous time is recorded in the travel distance of the memory #1 to which the value of the first front wheel unsprung velocity Vwf is input. In FIG. 9, since the travel distance is 1, and the travel distance recorded at the previous time is 0, 1 is stored in the travel distance of the memory #1. Since a sampling period Ts in which the front wheel unsprung velocity Vwf is detected is known, a travel distance may be obtained by calculating Va/Ts from the sampling period Ts and the velocity Va of the vehicle A.

When a front wheel unsprung velocity Vwf is detected at a third time, the third front wheel unsprung velocity Vwf is stored in the memory #3. Since a value of the third front wheel unsprung velocity Vwf is 2, the front wheel unsprung velocity Vwf is recorded as 2 in the memory #3. In addition, similarly to association of the travel distances with the first and second front wheel unsprung velocities Vwf, a travel distance associated with the front wheel unsprung velocity Vwf of the memory #3 becomes 0. On the other hand, a value by adding a distance in which the vehicle A travels from a time when the second front wheel unsprung velocity Vwf is detected, until a time when the third front wheel unsprung velocity Vwf is obtained to the travel distance updated last time is recorded in the travel distance of the memory #1 to which the value of the first front wheel unsprung velocity Vwf is input. That is, a travel distance of data having a number in which a front wheel unsprung velocity Vwf is recorded is updated with a value obtained by adding a travel distance obtained this time to a travel distance recorded up to the last time. In FIG. 9, since a travel distance from the second time to the third time is 2, 2 corresponding to a travel distance at this time is added to 1 corresponding to the travel distance of the memory #1 recorded up to the last time, and a value of the travel distance of the memory #1 is updated with 3. That is, when a new front wheel unsprung velocity Vwf is defected and recorded in the storage unit 5, a travel distance from a time when a previous front wheel unsprung velocity Vwf is detected up to a time when a newest front wheel unsprung velocity Vwf is detected is recorded in a travel distance of data having a number in which the previous front wheel unsprung velocity Vwf is recorded. Similarly, since a value of a travel distance recorded up to the last rime is 0, 2 corresponding to a travel distance at this time is added thereto, and a travel distance of the memory #2 becomes 2.

Thereafter, when front wheel unsprung velocities Vwf are successively detected, a front wheel unsprung velocity Vwf is recorded in data having a number next larger than a number of data with which a front wheel unsprung velocity Vwf is updated last time. When a front wheel unsprung velocity Vwf is recorded in the memory #8, a front wheel unsprung velocity Vwf detected next time is overwritten on and recorded in the memory #1. That is, in this embodiment, eight data items may be recorded in the storage unit 5. Further, when the number of times of detection of the front wheel unsprung velocity Vwf exceeds nine, a value of a front wheel unsprung velocity Vwf obtained in the past is updated with a newly obtained front wheel unsprung velocity Vwf from a ninth detection. Then, when the front wheel unsprung velocity Vwf is updated with a newly obtained value, a travel distance is reset to 0. Therefore, a travel distance in data of each number corresponds to a distance in which the vehicle A travels from a time when a front wheel unsprung velocity Vwf in the same data is detected up to a present time.

In a case where data is recorded in the storage unit 5 by associating the travel distance with the front wheel unsprung velocity Vwf as described above, for example, when the wheel base length L is 14, a front wheel unsprung velocity Vwf to be employed as a rear wheel unsprung velocity Vwr may be extracted with reference to data in which the travel distance is 14. A distance from the front wheel Wf to the rear wheel Wr equals the wheel base length L. In addition, a travel distance stored in data corresponds to a distance in which the vehicle travels from when the front wheel unsprung velocity Vwf is obtained until a present time. In this way, with reference to data having a number in which a travel distance equals the wheel base length L, a front wheel unsprung velocity Vwf detected when the front wheel Wf travels on the road surface r1 may be obtained at a time when the rear wheel Wr is considered to arrive at the road surface r1. Therefore, when data in which a travel distance equals the wheel base length L is selected, and a front wheel unsprung velocity Vwf stored in this data is used as a rear wheel unsprung velocity Vwr among front wheel unsprung velocities Vwf successively recorded in the storage unit 5, it is possible to estimate the rear wheel unsprung velocity Vwr without obtaining the time T.

When data in which a travel distance exactly equals the wheel base length L is not present, the rear wheel unsprung vibration information estimator 3 selects data in which a travel distance has a value closest to the wheel base length L and data having a value smaller than the wheel base length and second closest to the wheel base length when the closest value is larger than the wheel base length L or data having a value larger than the wheel base length and second closest to the wheel base length when the closest value is smaller than the wheel base length L. Then, the rear wheel unsprung vibration information estimator 3 obtains the front wheel unsprung velocity Vwf from two data items of the closest value and the second closest value selected as described above, and estimates the rear wheel unsprung velocity Vwr by performing linear interpolation such that the travel distance corresponds to the wheel base length. In FIG. 10, the rear wheel unsprung velocity Vwr obtained in this way is plotted in the X mark. In a state in which the travel distance is less than the wheel base length L, estimation is not allowed since the rear wheel Wr does not arrives at the road surface r1 passed by the front wheel Wf. In the case of this embodiment, this condition is not satisfied until the fifth record as illustrated in FIG. 9, and thus the rear wheel unsprung velocity Vwr may not be estimated. For this reason, the rear wheel unsprung vibration information estimator 3 is configured to set the value of the rear wheel unsprung velocity Vwr to 0. From a sixth record, data in which a travel distance is greater than or equal to the wheel base length L is present, and thus the rear wheel unsprung velocity Vwr may be estimated. Even though the number of data items recorded in the storage unit 5 is eight in the present example, the number of data items may be arbitrarily set.

In addition, the rear wheel unsprung vibration information estimator 3 estimates the rear wheel unsprung velocity Vwr using velocity information of the vehicle. In addition to the velocity Va of the vehicle A, the velocity information includes a travel distance obtained by dividing the velocity Va by the sampling period Ts, information obtained by processing the velocity Va such as a squared value of the velocity Va, and information allowing estimation of the velocity Va such as a rotational speed of the wheel.

A description will be given of a specific processing procedure in the rear wheel unsprung vibration information estimator 3 at the time of estimating the rear wheel unsprung velocity Vwr by extracting data of the front wheel unsprung velocity Vwf to be used as the rear wheel unsprung velocity Vwr without obtaining the time T described above.

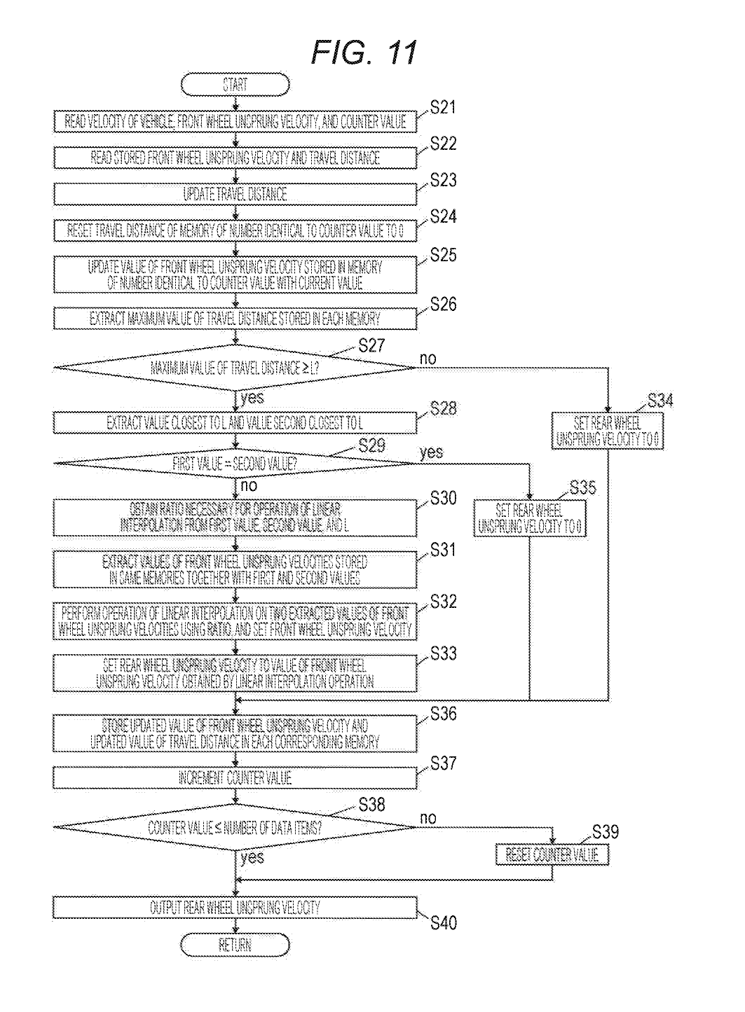

As illustrated in FIG. 11, the rear wheel unsprung vibration information estimator 3 reads the velocity Va detected by the velocity sensor 14, a current front wheel unsprung velocity Vwf detected by the front wheel unsprung vibration information detector 1, and a current, counter value (step S21).

Subsequently, the rear wheel unsprung vibration information estimator 3 reads a front wheel unsprung velocity Vwf and a travel distance stored in each memory of the storage unit 5 (step S22), and obtains a travel distance to update a value by adding the obtained travel distance to the read travel distance in each memory (step S23).

The rear wheel unsprung vibration information estimator 3 rewrites a travel distance of a memory having a number identical to the counter value to 0 to reset the travel distance to 0 with reference to the counter value (step S24), and updates a value of a front wheel unsprung velocity Vwf stored in the memory having the number identical to the counter value with a value of a current front wheel unsprung velocity Vwf (step S25).

The rear wheel unsprung vibration information estimator 3 extracts a maximum value of the travel distance stored in each memory (step S26), and determines whether the maximum value of the travel distance is greater than or equal to the wheel base length L (step S27). A case in which the maximum value of the travel distance is less than the wheel base length L as a result of determination corresponds to a state in which the rear wheel Wr does not arrive at the road surface r1 passed by the front wheel Wf. Therefore, the rear wheel unsprung vibration information estimator 3 may not estimate the rear wheel unsprung velocity Vwr, and thus sets the rear wheel unsprung velocity Vwr to 0 (step S34) and proceeds to processing of step S36. On the other hand, when the maximum value of the travel distance is greater than or equal to the wheel base length L, the rear wheel unsprung vibration information estimator 3 extracts a value of the travel distance closest to the wheel base length L and a value of the travel distance second closest to the wheel base length L (step S28).

Subsequent to processing of step S28 of extracting a first value of the travel distance closest to the wheel base length and a second value thereof second closest thereto, the rear wheel unsprung vibration information estimator 3 determines whether the extracted travel distances are equal to each other (step S29). When the extracted travel distances are equal to each other as a result thereof, the vehicle is at rest. Therefore, the rear wheel unsprung vibration information estimator 3 is not required to estimate the rear wheel unsprung velocity Vwr, and thus sets the rear wheel unsprung velocity Vwr to 0 (step S35), and proceeds to processing of step S36. On the other hand, when the extracted travel distances are different from each other, the rear wheel unsprung vibration information estimator 3 obtains a ratio necessary for operation of linear interpolation from the first value, the second value, and the wheel base length L (step S30).

Subsequently, the rear wheel unsprung vibration information estimator 3 extracts a value of a front wheel unsprung velocity Vwf stored in the same memory together with the first value and a value of a front wheel unsprung velocity Vwf stored in the same memory together with the second value (step 331), and performs an operation of linear interpolation on the two extracted values of the front wheel unsprung velocities Vwf using the ratio obtained in step S30, thereby estimating a front wheel unsprung velocity Vwf at a time when the travel distance corresponds to the wheel base length L (step S32). The rear wheel unsprung vibration information estimator 3 sets the rear wheel unsprung velocity Vwr to a value of the front wheel unsprung velocity Vwf obtained by the linear interpolation operation (step S33).

Then, the rear wheel unsprung vibration information estimator 3 stores a value of the front wheel unsprung velocity Vwf and a value of the travel distance updated by processing so far in each corresponding memory (step S36).

The rear wheel unsprung vibration information estimator 3 adds 1 to the counter value (step S37), and compares the counter value with the number of data items stored in all memories (step S38). When the counter value exceeds the number of stored data items as a result of comparison, the number of data items of the front wheel unsprung velocity Vwf stored in the storage unit 5 is equal to the number of memories provided in the storage unit 5. Thus, the counter value is reset to 1 (step S39) such that data of front wheel unsprung velocities Vwf recorded from a subsequent time is recorded by overwriting the data on memories in which old data is recorded to update the memories in order from the oldest data, and the operation proceeds to step S40. When the counter value is less than or equal to the number of stored data items, a memory having a number identical to the counter value is present among the stored data items of the front wheel unsprung velocities Vwf, and the memory having the number needs to be updated. Thus, the counter value may not be reset, and the operation proceeds to step S40.

Finally, the rear wheel unsprung vibration information estimator 3 outputs the rear wheel unsprung velocity Vwr estimated by performing the above-described processing procedure to the suspension vibration information estimator 4 (step S40). The rear wheel unsprung vibration information estimator 3 is configured to repeatedly perform the above described series of processes, thereby continuously estimating the rear wheel unsprung velocity Vwr.

In the suspension vibration information estimation device E of the present embodiment, as illustrated in FIG. 1, the rear wheel sprung vibration information detector 2 is configured to detect a rear wheel sprung velocity Vbr corresponding to a vertical velocity of the vehicle body B immediately above the rear wheel Wr as rear wheel sprung vibration information corresponding to sprung vibration information on the rear wheel Wr side. Similarly to the case of the above-described front wheel sprung velocity Vbf, the rear wheel sprung vibration information detector 2 includes an acceleration calculation unit 2a upon detection of the rear wheel sprung velocity Vbr, and obtains vertical acceleration immediately above the rear wheel Wr from vertical accelerations of the vehicle body B detected by the three acceleration sensors G1, G2, and G3 using the acceleration calculation unit 2a. Subsequently, the rear wheel sprung vibration information detector 2 is configured to detect the rear wheel sprung velocity Vbr by integrating the acceleration.

Since the rear wheel sprung velocity Vbr is obtained by integrating the acceleration immediately above the rear wheel Wr, the rear wheel sprung vibration information detector 2 includes a second integration low pass filter 20. The second integration low pass filter 20 may obtain a value corresponding to an integrated value of the acceleration by filtering the acceleration. Therefore, the second integration low pass filter 20 may obtain the rear wheel, sprung velocity Vbr by filtering the acceleration. When acceleration is integrated in this way, an integral drift becomes an issue. The rear wheel sprung vibration information detector 2 includes a second low frequency removal high pass filter 21 to remove the integral drift from the rear wheel sprung velocity Vbr obtained by processing in the second integration low pass filter 20. Therefore, the rear wheel sprung vibration information detector 2 may obtain the rear wheel sprung velocity Vbr, from which a low frequency component is eliminated and thus the integral drift is removed, by filtering the rear wheel sprung velocity Vbr using the second low frequency removal high pass filter 21. A cutoff frequency of the second low frequency removal high pass filter 21 is in a lower frequency range than a sprung resonance frequency, so that a sprung resonance frequency component is not removed from the rear wheel sprung velocity Vbr. The acceleration may be filtered by the second low frequency removal high pass filter 21 before the second integration low pass filter 20, and an order of processing may be arbitrarily changed. In addition, the rear wheel sprung vibration information detector 2 may not separately include the second integration low pass filter 20 and the second low frequency removal high pass filter 21. Instead, the rear wheel sprung vibration information detector 2 may include a single band pass filter having a characteristic obtained by synthesizing characteristics of the second integration low pass filter 20 and the second low frequency removal high pass filter 21, and perform processing using this band pass filter.

The rear wheel sprung velocity Vbr obtained in this way is used for the suspension vibration information estimator 4 to estimate the suspension velocity Vsr on the rear wheel side. In the case of this embodiment, the suspension vibration information estimator 4 obtains the suspension velocity Vsr on the rear wheel side by subtracting the rear wheel sprung velocity Vbr from the rear wheel unsprung velocity Vwr.

Therefore, in a practical area, in general, in a frequency band of 1 Hz to 10-odd Hz in the case of the vehicle, a conformity degree of a phase characteristic and a gain characteristic of the rear wheel sprung velocity Vbr and the rear wheel unsprung velocity Vwr obtained by processing in the second integration low pass filter 20 and the second low frequency removal high pass filter 21 may be increased.

Acceleration immediately above the rear wheel Wr is processed by the second integration low pass filter 20 and the second low frequency removal high pass filter 21 to obtain the rear wheel sprung velocity Vbr, and the rear wheel unsprung velocity Vwr is processed by the first integration low pass filter 10, the first low frequency removal high pass filter 11, the differentiation high pass filter 12, and the high frequency removal low pass filter 13, thereby increasing a conformity degree of gain characteristics of both information items in the practical area, and improving accuracy of the suspension velocity Vsr on the rear wheel side obtained from the both information items.

When the integral drift is not an issue, the second low frequency removal high pass filter 21 maybe removed. An integral of the acceleration immediately above the rear wheel Wr may be obtained by integral calculation without depending on the second integration low pass filter 20.

Further, when a characteristic obtained by synthesizing characteristics of the first integration low pass filter 10 and the first low frequency removal high pass filter 11, a characteristic obtained by synthesizing characteristics of the differentiation high pass filter 12 and the high frequency removal low pass filter 13, and a characteristic obtained by synthesizing characteristics of the second integration low pass filter 20 and the second low frequency removal high pass filter 21 are equalized, it is possible to conform gain characteristics of the rear wheel sprung velocity Vbr and the rear wheel unsprung velocity Vwr to each other and mitigate a phase characteristic shift therebetween, and it is possible to increase a conformity degree of the obtained suspension velocity Vsr and an actual suspension velocity.

As described above, the suspension vibration information estimator 4 obtains the suspension velocity Vsr on the rear wheel side as suspension vibration information on the rear wheel Wr side in the vehicle A by subtracting the rear wheel sprung velocity Vbr from the rear wheel unsprung velocity Vwr based on the rear wheel unsprung velocity Vwr as estimated rear wheel unsprung vibration information and the rear wheel sprung velocity Vbr as rear wheel sprung vibration information.

In this way, the suspension vibration information estimation device E of the present invention obtains the suspension vibration information on the rear wheel Wr side in the vehicle A based on the rear wheel unsprung vibration information and the rear wheel sprung vibration information, and estimates the suspension vibration information by considering a vibration state of the vehicle body B on the rear wheel side. Therefore, the suspension vibration information estimation device E of the present invention may accurately estimate the suspension vibration information on the rear wheel Wr side.

When the rear wheel Wr vibrates, the vehicle body B inevitably vibrates. Further, a coupled vibration component is super imposed on the rear wheel unsprung velocity Vwr and the rear wheel sprung velocity Vbr. In addition, a lever ratio of a suspension of the rear wheel Wr is set. In a case where an error that may not be overlooked occurs between the suspension velocity Vsr and an actual suspension velocity due to an influence of the coupled vibration component and the lever ratio described above when a value obtained by subtracting the rear wheel sprung velocity Vbr from the rear wheel unsprung velocity Vwr is used as the suspension velocity Vsr on the rear wheel side without change, the suspension velocity Vsr may be accurately conformed to the actual suspension velocity by providing the compensation gain multiplier 6 as illustrated in FIG. 1 to multiply a compensation gain by the suspension velocity Vsr, thereby eliminating the influence of the coupled vibration component and the lever ratio. The compensation gain multiplier 6 may be omitted. In the above description, the suspension velocity Vsr is obtained by subtracting the rear wheel sprung velocity Vbr from the rear wheel unsprung velocity Vwr. However, depending on the scheme of assigning signs to the rear wheel sprung velocity Vbr and the suspension velocity Vsr, the suspension velocity Vsr may be obtained by subtracting the rear wheel unsprung velocity Vwr from the rear wheel sprung velocity Vbr or by adding the rear wheel sprung velocity Vbr and the rear wheel unsprung velocity Vwr.

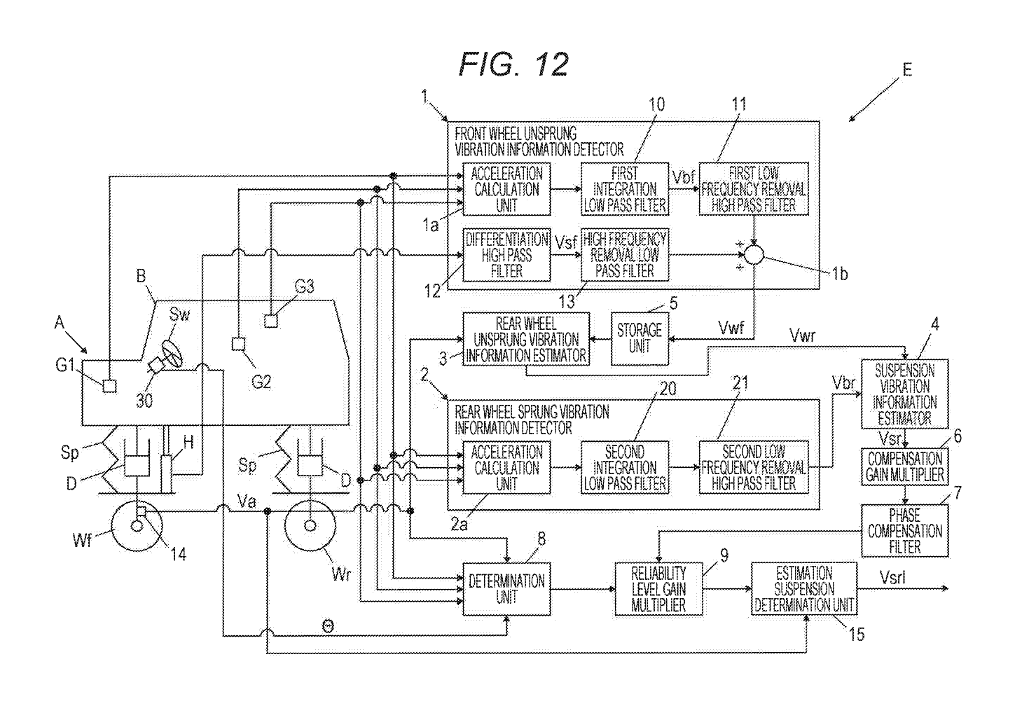

In addition, when a phase shift that may not be overlooked occurs between the actual suspension velocity and the suspension velocity Vsr obtained by the suspension vibration information estimator 4, a phase of the suspension velocity Vsr may be conformed to a phase of the actual suspension velocity by providing a phase compensation filter 7 as illustrated in FIG. 12. It is possible to obtain the more accurate suspension velocity Vsf by conforming the phases to each other as described above.

Incidentally, in the above description, the suspension vibration information estimation device E estimates the suspension velocity Vsr on the rear wheel Wr side on the assumption that the rear wheel Wr passes the same road surface r1 as the road surface r1 passed by the front wheel Wf. However, in a state in which the rear wheel Wr does not pass the road surface r1, a reliability level at which the estimated suspension velocity Vsr is identical to the actual suspension velocity (a reliability level of the suspension velocity Vsr) decreases.

For example, considering that the suspension velocity Vsr estimated by the suspension vibration information estimation device E is used by the control device C that controls the damper D, which may adjust a damping force, interposed between the vehicle body 3 and the rear wheel Wr in the vehicle A as illustrated in FIG. 13, in a case where a reliability level of the estimated suspension velocity Vsr is low, a possibility that an excellent result may not be obtained by damping control on the vehicle body B or the rear wheel Wr increases when the control device C controls the damping force of the damper D based on the suspension velocity Vsr having the low reliability level. The suspension velocity Vsr is equivalent to a damper velocity corresponding to an expansion/contraction velocity of the damper D interposed between the rear wheel Wr and the vehicle body B, and the damper velocity is obtained in the suspension vibration information estimation device E of the present embodiment. Since the damper D exerts the damping force with respect to the damper velocity, it is possible to provide information suitable for the control device C that controls the damping force of the damper D by obtaining the damper velocity using the suspension vibration information estimation device E as described above.

Therefore, when the reliability level of the suspension velocity Vsr is low as described above, it is not preferable to estimate the suspension velocity Vsr using the suspension vibration information estimation device E, or it is preferable to take measures by outputting an error signal rather than outputting the estimated suspension velocity Vsr to the control device C without change.

In this regard, as illustrated in FIG. 1, a determination unit 8 that determines a reliability level at which the suspension velocity Vsr obtained by the suspension vibration information estimator 4 is identical to an actual suspension velocity on the rear wheel Wr side is provided in the suspension vibration information estimation device E of the present embodiment.

Upon determination of the reliability level, the determination unit 8 may obtain the reliability level as a numerical value or determine the presence/absence of the reliability level. In the case of this embodiment, as illustrated in FIG. 1, the determination unit 8 obtains a reliability level as a numerical value, and outputs the reliability level to a reliability level gain multiplier 9. The reliability level gain multiplier 9 obtains a reliability level gain P depending on the reliability level, and multiplies the reliability level gain P by the suspension velocity Vsr obtained by the suspension vibration information estimator 4. Therefore, the suspension vibration information estimation device E of the present embodiment is configured to output the suspension velocity Vsr multiplied by the reliability level gain P as a final suspension velocity Vsr1.

The reliability level of the suspension velocity Vsr decreases in a state in which the rear wheel Wr does not pass the road surface r1 passed by the front wheel Wf as described above. Examples of a case in which a possibility that the rear wheel Wr will not pass the road surface r1 passed by the front wheel Wf increases may include a case (1) in which a steering angle of the steering wheel is large, a case (2) in which counter-steering is performed while the vehicle is turning, a case (3) of traveling with remarkable understeer, a case (4) of drift drive in which four wheels slide in neutral steer, and a case (5) in which the vehicle is moving backward.

In the case (1), the steering angle of the steering wheel of the vehicle A may be monitored. In the case (2) to the case (4), it is possible to determine a reliability level from an amount of difference or a degree of difference between lateral acceleration actually acting on the vehicle body B and lateral acceleration of the vehicle body B estimated from the velocity Va and the steering angle of the steering wheel. A value referred to as a stability factor may be obtained from the lateral acceleration actually acting on the vehicle body B, the velocity Va, and a steering angle θ of the steering wheel to determine a reliability level from the value of the stability factor. Further, in the case (5), the velocity Va of the vehicle A may be monitored.

Even when the rear wheel Wr passes the road surface r1 passed by the front wheel Wf unlike the above-described case, the reliability level of the suspension velocity Vsr decreases in a case (6) in which a velocity change between a velocity at which the front wheel Wf passes the road surface r1 and a velocity at which the rear wheel Wr passes the road surface r1 is large. The case (6) will be described in detail below.

Hereinafter, a more detailed description will be given of a determination scheme in the determination unit 8 for each case. In the case (1), a reliability level is decreased when the steering angle is large. When the vehicle A is turning, a radius of a trajectory is different between the front wheel Wf and the rear wheel Wr lined up in the front-rear direction of the vehicle A due to an inner wheel difference or an outer wheel difference, and a trajectory radius of the front wheel Wf is larger than a trajectory radius of the rear wheel Wr. In addition, as the steering angle of the front wheel Wf of the vehicle A increases, the inner wheel difference or the outer wheel difference increases. As described above, as illustrated in FIG. 1, the steering angle θ may be detected from a medium position of a steering wheel Sw of the vehicle A using a steering angle sensor 30, and the reliability level of the suspension velocity Vsr may be obtained by the determination unit 8 based on the steering angle θ. Specifically, a threshold value θa may be provided with respect to an absolute value of the steering angle θ. Then, the reliability level may be gradually decreased when the threshold value θa is exceeded, or the reliability level may be set to 0 when the absolute value of the steering angle θ exceeds the threshold value θa. For example, the threshold value θa may be set to a steering angle at which the rear wheel Wr reliably does not pass the road surface r1 passed by the front wheel Wf due to the inner wheel difference or the outer wheel difference. Specific setting of the threshold value θa may be obtained from the wheel base length L and a tread length.

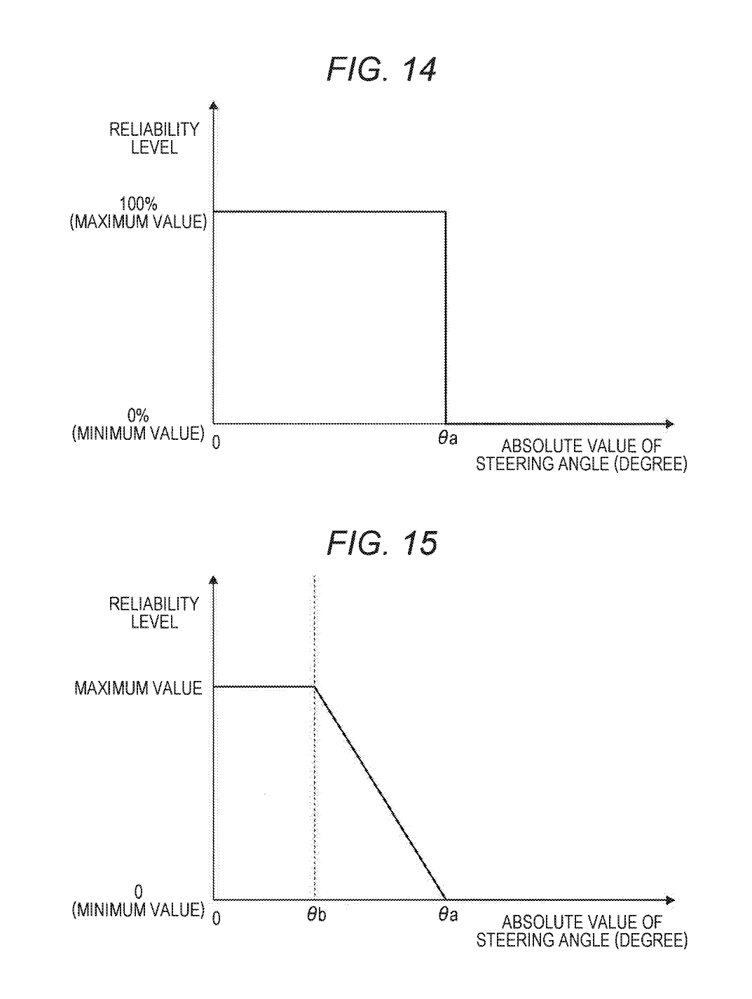

In a case where it is considered that the road surface r1 has a characteristic unrelated to a surrounding road surface at this point, when the steering angle θ exceeds the threshold value θa, the rear wheel Wr does not travel on the road surface r1 passing the front wheel Wf. Thus, the determination unit θ sets the reliability level to a minimum value, for example, 0. On the contrary, when the absolute value of the steering angle θ is within a range of the threshold value θa, the determination unit θ may set the reliability level to a preset maximum value and output the set reliability level to the reliability level gain multiplier 9. In other words, as illustrated in FIG. 14, a value, which may be taken as a reliability level, is set to the minimum value or the maximum value. The minimum value and the maximum value of the reliability level may be arbitrarily set. For example, as illustrated in FIG. 14, the minimum value may be set to 0%, and the maximum value may be set to 100% when the values are expressed in percentage.

On the other hand, in a case where it is considered that the road surface r1 is affected by a shape of the surrounding road surface at the point, when the steering angle θ exceeds the threshold value θa, the rear wheel Wr does not travel on the road surface r1 passing the front wheel Wf. Thus, the determination unit 8 sets the reliability level to a minimum value. On the contrary, for example, when the absolute value of the steering angle θ is within a range of the threshold value θa, the determination unit 8 may change the reliability level between the minimum value and the maximum value. In other words, a value of the reliability level may be changed depending on a magnitude of the steering angle θ. As illustrated in FIG. 15, the reliability level may be set to the maximum value when a value of the absolute value of the steering angle θ is within a range of a steering angle in which the rear wheel Wr is considered to reliably pass the road surface r1 passed by the front wheel Wf, and the reliability level may be changed from the maximum value to the minimum value within a range up to the threshold value beyond a range up to the steering angle θb. In this embodiment, the determination unit 8 determines the reliability level using the steering angle θ of the steering wheel Sw. However, the reliability level may be determined using steering angle information that allows specification of the steering angle θ. The steering angle information includes an actual steering angle of a steering control wheel or information obtained by processing the steering angle θ in addition to the steering angle θ.

In the case (2) to the case (4), the vehicle A does not turn according to the steering angle θ, and the vehicle A is in a skidding state. In such a case, the vehicle body B is sliding in a lateral direction, and thus it is impossible to predict that the rear wheel Wr will pass the road surface r1 passed by the front wheel Wf. Therefore, when it is determined that such a state occurs, the determination unit 8 lowers the reliability level.

Lateral acceleration acting on the vehicle body B while the vehicle A is turning has radial acceleration acting on the vehicle body B as a result of turning of the vehicle A as a main component. A turning radius of the vehicle A is determined by the steering angle θ on the assumption that the front wheel Wf and the rear wheel Wr are not skidding, and a tangential velocity corresponds to the velocity Va detected by the velocity sensor 14. Thus, when the steering angle θ and the velocity Va are known, it is possible to estimate the lateral acceleration acting on the vehicle body B while the vehicle A is turning.

Specifically, when a steering angle of the front wheel Wf corresponding to an actual steering control wheel is set to θw with respect to the steering angle θ of the steering wheel Sw, the steering angle θ and the steering angle θw are in a proportional relationship, and the turning radius of the vehicle A may be obtained from the wheel base length L and the steering angle θw. The lateral acceleration acting on the vehicle body B while the vehicle A is turning may be obtained by dividing a value obtained by squaring the velocity Va by the turning radius. Specifically, the lateral acceleration may be obtained by calculating an equation of acceleration=Va²·θw/L. Therefore, the lateral acceleration acting on the vehicle body B may be estimated by obtaining the steering angle θ and the velocity Va. Then, the determination unit 8 obtains the steering angle θ and the velocity Va from the steering angle sensor 30 and the velocity sensor 14 to estimate the lateral acceleration acting on the vehicle body B as described above. It is sufficient for the determination unit 8 to know the steering angle θw of the steering control wheel. An actual steering angle θw of the front wheel Wf rather than the steering angle θ of the steering wheel Sw may be detected to determine a reliability level. Alternatively, when the steering control wheel corresponds to the rear wheel Wr, an actual steering angle of the rear wheel Wr may be detected to determine a reliability level.

As described above, in the case (2) to the case (4), the vehicle A is in the skidding state rather than turning according to the steering angle θ. Thus, a difference occurs between actual lateral acceleration α acting on the vehicle body B and lateral acceleration estimated as described above. The actual lateral acceleration α may be obtained from accelerations detected by the acceleration sensors G1, G2, and G3 by presuming that the vehicle body B is a rigid body. Then, the determination unit 8 is configured to detect the lateral acceleration actually acting on the vehicle body B from the accelerations detected by the acceleration sensors G1, G2, and G3. The lateral acceleration may be detected by providing an acceleration sensor separately from the acceleration sensors G1, G2, and G3.

The determination unit 8 obtains a reliability level from a difference between the actual acceleration α and the estimated acceleration. Specifically, the determination unit 8 may examine a ratio of a deviation between the acceleration α and the estimated acceleration to the acceleration α, obtain a conformity degree between the acceleration α and the estimated acceleration, and use the obtained conformity degree as a reliability level, or may map a relationship between the deviation and the reliability level, and obtain a reliability level from the deviation.

In addition, in the case (2) to the case (4), the vehicle A is in the skidding state, and thus a reliability level may be obtained by obtaining a stability factor. When the stability factor is set to Sf, a relationship of α=Va²·θw/{(1+Sf·Va²)·L} is present among the lateral acceleration a acting on the vehicle body B, the velocity Va, the wheel base length L, the actual steering angle θw of the front, wheel Wf corresponding to the steering control wheel. The acceleration α, the velocity Va, and the steering angle θw may be detected by a sensor as described above. Further, the wheel base length L is previously known. Thus, the stability factor Sf may be calculated.

When the stability factor Sf has a value of 0, an equation of acceleration α=Va²·θw/L is obtained, and Va²·θw/L is the radial acceleration, Thus, it is understood that the vehicle A is skidding. The vehicle A is in a state of understeer when the stability factor Sf has a positive value, and the vehicle A is in a state of oversteer when the stability factor Sf has a negative value. Therefore, it is possible to determine whether the vehicle A is in the skidding state by obtaining a value of the stability factor Sf.

When the stability factor Sf is obtained by the determination unit 8 as described above, since a degree of skidding of the vehicle A increases as a value of the stability factor Sf further deviates from 0, the reliability level decreases. For example, an absolute value of the stability factor Sf may be used as a parameter to map the absolute value and the reliability level, and a reliability level may be numerically obtained from the absolute value of the stability factor Sf. Alternatively, a threshold value may be provided, and the presence/absence of a reliability level may be determined based on the threshold value.

In addition, in the case (2) to the case (4), the vehicle A is in the skidding state rather than turning according to the steering angle θ of the steering wheel Sw, and an actual yaw rate of the vehicle A is different from a yaw rate estimated from the steering angle θ of the steering wheel Sw. Therefore, instead of obtaining the reliability level from a difference between the actual lateral acceleration α acting on the vehicle body B and the estimated lateral acceleration, the reliability level is obtained from a difference between the actual yaw rate of the vehicle A and the steering angle θ of the steering wheel Sw. The actual yaw rate of the vehicle A may be detected by providing a yaw rate sensor in the vehicle A. In addition, a yaw rate may be obtained by dividing a tangential velocity of the turning vehicle A by a turning radius. However, since the turning radius is obtained from the wheel base length L and the steering angle θ as described above, and the tangential velocity corresponds to the velocity Va, the yaw rate may be estimated using the velocity Va and the steering angle θ

Further, when the difference between the actual yaw rate of the vehicle A and the steering angle θ of the steering wheel Sw is large, the vehicle A is in the skidding state, and thus the reliability level decreases as the difference increases. Therefore, the reliability level is obtained when the difference is obtained. In the case (5), when the velocity Va is monitored, and it is determined that the vehicle A is moving backward based on a value of a detected velocity Va, the reliability level may be set to the minimum value. In addition, the vehicle may be determined to move backward by monitoring a gear position of a transmission.

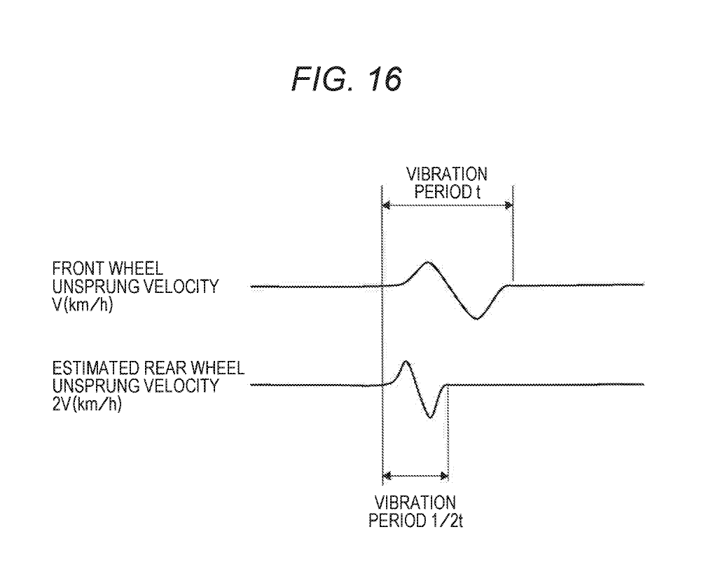

Next, a description will be given of processing in a case where a velocity change between a velocity at which the front wheel Wf passes the road surface r1 and a velocity at which the rear wheel Wr passes the road surface r1 is large corresponding to the case (6). First, a description will be given of the fact that a reliability level decreases when the front wheel unsprung vibration information is employed as the rear wheel unsprung vibration information at the time of acceleration and deceleration. During acceleration and deceleration or in the case of acceleration and deceleration from when the front wheel Wf passes the road surface r1, a velocity is not constant. However, a time required from when the front wheel Wf passes the road surface r1 until the rear wheel Wr arrives at the road surface r1 may be obtained by monitoring the velocity change of the velocity Va of the vehicle A. In principle, the front wheel unsprung velocity Vwf obtained the time, which is obtained by monitoring the velocity change as described above, ago may be estimated to be the rear wheel unsprung velocity Vwr of the rear wheel Wr on the assumption that the road surface r1 currently arrives at the rear wheel Wr. For example, when the rear wheel unsprung velocity Vwr is estimated as described above on the assumption that the velocity Va doubles after the front wheel Wf passes the road surface r1, a rear wheel unsprung velocity Vwr obtained by estimation with respect to a vibration waveform at the time of obtaining the front wheel unsprung velocity Vwf of the front wheel Wf has a vibration period compressed to one half as illustrated in FIG. 16. The front wheel Wf and the rear wheel Wr, which are unsprung members, correspond to a spring-mass system of a suspension spring interposed between a tire and the vehicle body B, and the front wheel Wf and the rear wheel Wr basically vibrate at a specific resonance frequency. As described above, a vibration frequency of the rear wheel unsprung velocity Vwr estimated after the velocity Va doubles is twice a vibration frequency of the front wheel unsprung velocity Vwf. However, in practice, since the resonance frequency of the rear wheel Wr does not change, the estimated rear wheel unsprung velocity Vwr is different from the actual rear wheel unsprung velocity Vwr. As the amount of change of the velocity Va of the vehicle A after the front wheel Wf passes the road surface r1 increases, a difference therebetween becomes more noticeable, and a reliability level decreases. In the above description, the case of acceleration after the front wheel Wf passes the road surface r1 has been described. However, in the case of deceleration, a vibration frequency of the estimated rear wheel unsprung velocity Vwr becomes lower than the resonance frequency. Therefore, at the time of deceleration, the estimated rear wheel unsprung velocity Vwr is different from the actual rear wheel unsprung velocity Vwr.

The determination unit 8 is configured to decrease a reliability level depending on a velocity change between a velocity at which the front wheel Wf passes the road surface r1 and a velocity at which the rear wheel Wr passes the road surface r1.

Specifically; focusing on the velocity Va at the time when the front wheel Wf passes the road surface r1, as the velocity Va increases, a time from when the front wheel Wf passes the road surface r1 until the rear wheel Wr passes the road surface r1 decreases. In addition, since the time from when the front wheel Wf passes the road surface r1 until the rear wheel Wr passes the road surface r1 corresponds to a time at which acceleration (acceleration in the front-rear direction of the vehicle A) at the time of acceleration or deceleration acts on the vehicle A, the amount of change in velocity decreases as the time decreases when the acceleration is constant. On the contrary, when the velocity Va of the vehicle A at the time when the front wheel Wf passes the road surface r1 decreases, an acting time at which acceleration at the time of acceleration and deceleration acts on the vehicle A increases, and thus the amount of change in velocity increases. Therefore, the difference between the estimated rear wheel unsprung velocity Vwr and the actual rear wheel unsprung velocity Vwr decreases as the velocity Va of the vehicle A at the time when the front wheel Wf passes the road surface r1 increases, and the difference between the estimated rear wheel unsprung velocity Vwr and the actual rear wheel unsprung velocity Vwr increases as the velocity Va increases. As described above, the reliability level at which the estimated rear wheel unsprung velocity Vwr is identical to the actual rear wheel unsprung velocity Vwr increases as the velocity Va of the vehicle A at the time when the front wheel Wf passes the road surface r1 increases, and the reliability level at which the estimated rear wheel unsprung velocity Vwr is identical to the actual rear wheel unsprung velocity Vwr decreases as the velocity Va decreases. In addition, as an absolute value of acceleration acting in the front-rear direction of the vehicle A increases, the amount of change in velocity increases, and thus the reliability level decreases.

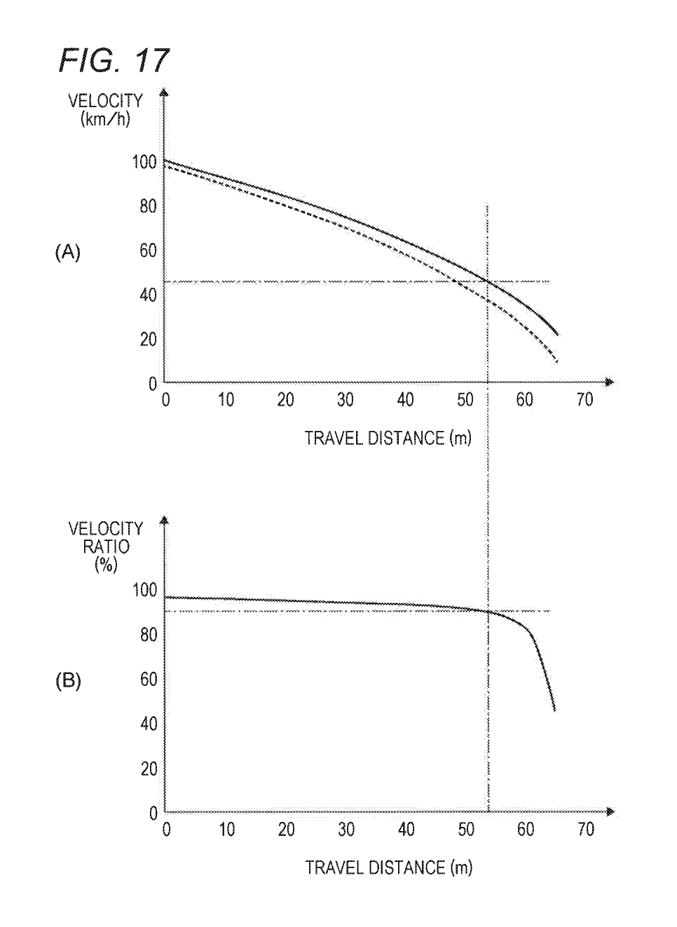

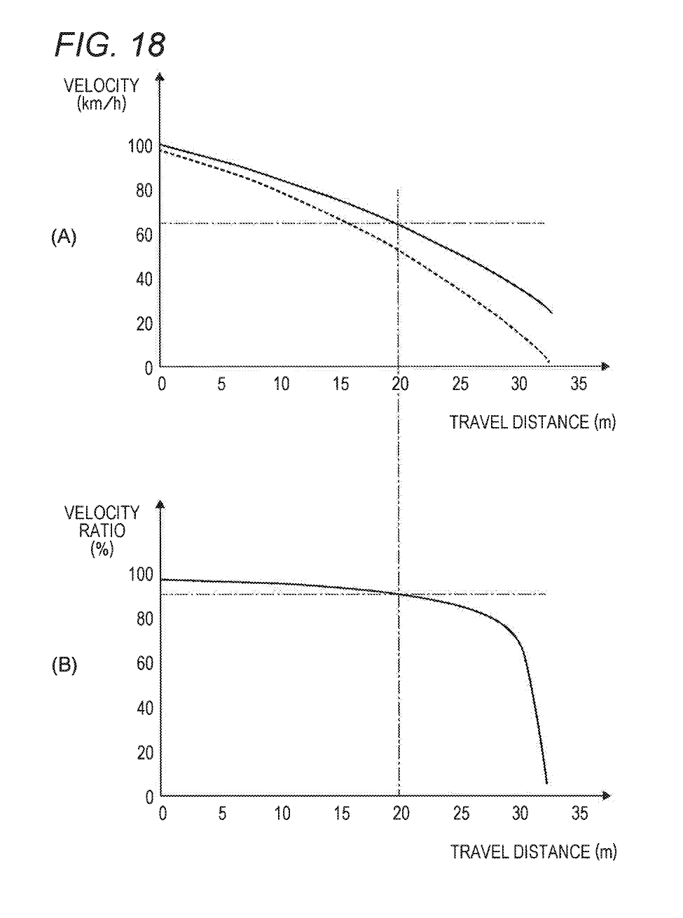

In this regard, in the case (6), the determination unit θ determines the reliability level based on the velocity Va and the acceleration in the front-rear direction of the vehicle A described above. Referring to the vehicle A having the wheel base length L of 2.5 m, in a case where the vehicle A traveling at 100 km/h is decelerated at an acceleration/deceleration rate of −20 km/s, when a vertical axis represents the velocity Va of the vehicle A, and a horizontal axis represents a travel distance of the vehicle A (a travel distance from when the front wheel or the rear wheel passes a certain spot), the velocity Va at the time when the front wheel Wf and the rear wheel Wr pass the same road surface changes as illustrated in FIG. 17 (A). A solid line of FIG. 17(A) indicates a velocity change of the vehicle A at the time when the front wheel Wf passes the road surface, and a broken line of the same figure indicates a velocity change of the vehicle A at the time when the rear wheel Wr passes the same road surface as that passed by the front wheel Wf. In addition, when a vertical axis represents a velocity ratio obtained by dividing a velocity of the vehicle A at the time when the rear wheel Wr passes a certain road surface by a velocity of the vehicle A at the time when the front wheel Wf passes the same road surface, and a horizontal axis represents a travel distance of the vehicle A, the velocity ratio changes as illustrated in FIG. 17(B). Focusing on a point at which the velocity ratio becomes 90%, when the velocity Va at the time when the front wheel Wf passes the road surface r1 becomes lower than 45 km/h, the velocity ratio is lower than 90%, and the amount of change in velocity at which the front wheel Wf and the rear wheel Wr pass the same road surface r1 increases. In addition, in a case where the vehicle A traveling at 100 km/h is decelerated at an acceleration/deceleration rate of −40 km/s, when a vertical axis represents the velocity Va of the vehicle A, and a horizontal axis represents a travel distance of the vehicle A (a travel distance from when the front wheel or the rear wheel passes a certain spot), the velocity Va at the time when the front wheel Wf and the rear wheel Wr pass the same road surface changes as illustrated in FIG. 18(A). In addition, when a vertical axis represents a velocity ratio obtained by dividing a velocity of the vehicle A at the time when the rear wheel Wr passes a certain road surface by a velocity of the vehicle A at the time when the front wheel Wf passes the same road surface, and a horizontal axis represents a travel distance of the vehicle A, the velocity ratio changes as illustrated in FIG. 18(B). A solid line of FIG. 18(A) indicates a velocity change of the vehicle A at the time when the front wheel Wf passes the road surface, and a broken line of the same figure indicates a velocity change of the vehicle A at the time when the rear wheel Wr passes the same road surface as that passed by the front wheel Wf. Focusing on a point at which the velocity ratio becomes 90%, when the velocity Va at the time when the front wheel Wf passes the road surface r1 becomes lower than 65 km/h, the velocity ratio is lower than 90%, and the amount of change in velocity at which the front wheel Wf and the rear wheel Wr pass the same road surface r1 increases.

At the time of deceleration, a velocity ratio β is obtained by dividing a velocity of the vehicle A at the time when the rear wheel Wr passes a certain road surface by a velocity of the vehicle A at the time when the front wheel Wf passes the road surface. At the time of acceleration, a velocity ratio γ is obtained by dividing a velocity of the vehicle A at the time when the front wheel Wf passes a certain road surface by a velocity of the vehicle A at the time when the rear wheel Wr passes the road surface. Then, in a state in which the velocity ratio β or the velocity ratio γ becomes 90%, a vibration period of the estimated rear wheel unsprung velocity Vwr is 0.9 times a vibration period of the actual rear wheel unsprung velocity Vwr at the time of deceleration, and is about 1.1 times the vibration period at the time of acceleration. Therefore, when the velocity ratios β and γ are 90% or less, a deviation of 10% or more occurs between the vibration period of the estimated rear wheel unsprung velocity Vwr and the vibration period of the actual rear wheel unsprung velocity Vwr, and it is determined that a degree at which the vibration periods are identical to each other is low, and a reliability level is low. In the present embodiment, the reliability level is set to 0 when the velocity ratio becomes 90% or less.

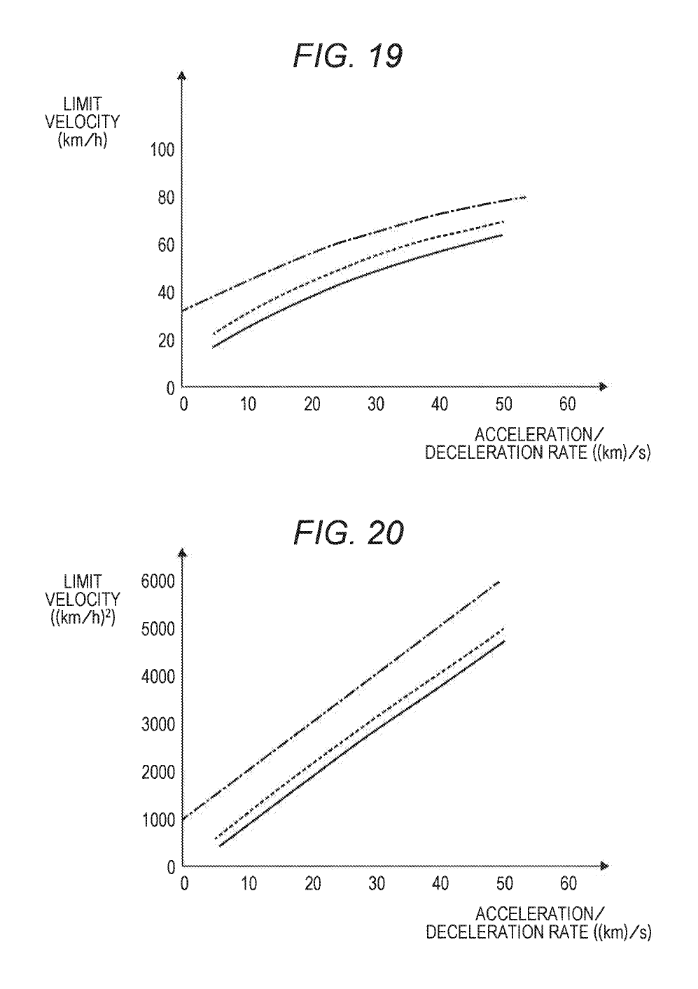

A relationship between an acceleration/deceleration rate and a limit velocity Vlim at which the velocity ratios β and γ become 90% is illustrated in FIG. 19. As illustrated in FIG. 19, as the acceleration/deceleration rate increases, the limit velocity increases. This tendency is similarly applied during both deceleration and acceleration. In addition, values at which the velocity ratios β and γ become 93% are plotted in a graph, and the reliability level is gradually decreased in a range from an average velocity of a velocity at which the velocity ratio β becomes 93% and a velocity at which the velocity γ become 93% up to a velocity at which the velocity ratios β and γ become 90%. In FIG. 19, a solid line plots a velocity at which the velocity ratio γ become 90% at the time of acceleration, a broken line plots a velocity at which the velocity ratio β become 90% at the time of deceleration, and a dashed line plots an average velocity of a velocity at which the velocity ratio β becomes 93% and a velocity at which the velocity ratio γ becomes 93%. Hereinafter, this dashed line is expressed as a boundary velocity line. For example, when a reliability level is expressed in percentage, a reliability level at the time when a relation between a velocity and an acceleration/deceleration rate is on this boundary velocity line is set to 100%, a reliability level at the time when the velocity ratios β and γ are 90% is set to 0%, and a reliability level is linearly changed in an interval between the boundary velocity line and a value at which the velocity ratios β and γ are 90%. Therefore, the determination unit 8 may map and hold the limit velocity illustrated in FIG. 19 and a relation between an acceleration/deceleration rate and an average velocity of a velocity at which the velocity ratio β becomes 33% and a velocity at which the velocity ratio γ becomes 93%, and obtain a reliability level as a value from the velocity Va and the acceleration/deceleration rate. When a vertical axis represents a squared value of the limit velocity, the squared value of the limit velocity has a characteristic that the squared value is substantially proportional to the acceleration/deceleration rate as illustrated in FIG. 20. In addition, when the acceleration/deceleration rate and the average velocity of the velocity at which the velocity ratio β becomes 93% and the velocity at which the velocity ratio γ becomes 93% are plotted on the same figure, the average velocity similarly changes in proportion to the acceleration/deceleration rate. As described above, the average velocity of the velocity at which the velocity ratio β becomes 93% and the velocity at which the velocity ratio γ become 93%, and the velocity at which velocity ratios β and γ become 90% may be obtained from the acceleration/deceleration rate using an arithmetic expression rather than a map, and the obtained velocities may be used as a threshold value and compared with a current velocity to obtain a reliability level. In FIG. 20, a solid line plots a velocity at which the velocity ratio γ become 90% at the time of acceleration, a broken line plots a velocity at which the velocity ratio β become 90% at the time of deceleration, and a dashed line plots the average velocity of the velocity at which the velocity ratio β becomes 93% and the velocity at which the velocity ratio γ becomes 93%.

In the above description, it is determined such that the reliability level is set to 0% using the velocity at which the velocity ratios β and γ become 90% as a threshold value. However, the threshold value may be set at the velocity ratios β and γ having a value other than 90% depending on the specification of the vehicle, etc. Since the wheel base length L affects a time from when the front wheel Wf passes the road surface r1 until the rear wheel Wr arrives at the road surface r1, the map and the arithmetic expression held by the determination unit 8 may be set in consideration of the wheel base length L.

Hereinbefore, the determination unit 8 selects (low-selects) a reliability level having a smallest value among a reliability level obtained from the steering angle θ of the steering wheel Sw in the case (1), a reliability level obtained from a viewpoint as to whether the vehicle A is in the skidding state in the case (2) to the case (4), a reliability level obtained by determining whether the vehicle A is moving backward in the case (5), and a reliability level obtained from the velocity Va and the acceleration/deceleration rate in the case (6), and outputs the selected reliability level to the reliability level gain multiplier 9.

The reliability level gain multiplier 9 obtains a reliability level gain using a map or an arithmetic expression for obtaining a reliability level gain from a reliability level, multiplies the reliability level gain by the suspension velocity Vsr obtained by the suspension vibration information estimator 4, and outputs the reliability level gain multiplied by the suspension velocity Vsr. When the phase compensation filter 7 is provided as illustrated in FIG. 12, the reliability level gain may be multiplied by an output of the phase compensation filter 7, or the reliability level gain may be multiplied by the suspension velocity Vsr obtained by the suspension vibration information estimator 4 at a former stage of the phase compensation filter 7.

The determination unit 8 obtains four reliability levels in the case of the case (1) to the case (6). However, only some of the four reliability levels may be obtained. However, since a state in which the rear wheel Wr may not pass the same road surface r1 as that passed by the front wheel Wf may be covered in many facets by obtaining and low-selecting all the above-described reliability levels, it is possible to obtain a suspension velocity Vsr having high reliability. The suspension velocity Vsr on the rear wheel side may be obtained without providing the determination unit 8. However, since a reliability level of the rear wheel unsprung velocity Vwr estimated by the determination unit 8 is obtained, and the reliability level is taken into consideration by the reliability level gain multiplier 9 to obtain a suspension velocity Vsr as suspension vibration information, a suspension velocity Vsr having a high conformity degree may be obtained from an actual suspension velocity. In addition, the determination unit 8 uses the velocity Va of the vehicle A in the front-rear direction at the time of performing determination of case (2) to case (6). However, determination may be performed using velocity information of the vehicle. The velocity information is a concept including information obtained by processing the velocity Va such as a squared value of the velocity Va of the vehicle A and information allowing estimation of the velocity Va such as a rotational speed of the wheel as described above.

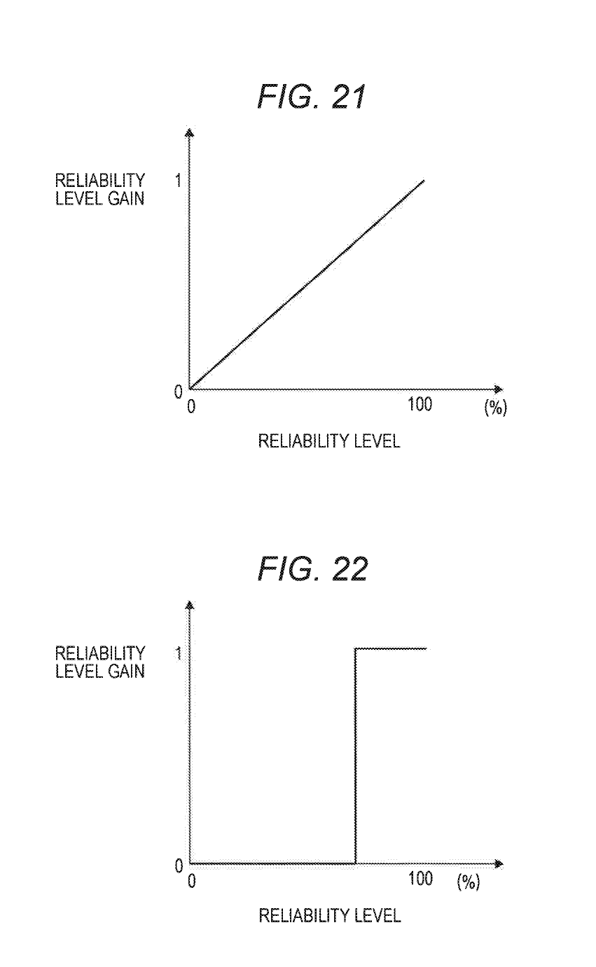

The reliability level gain multiplier 9 obtains a reliability level gain by associating the reliability level gain with a value of a reliability level expressed in percentage. For example, as illustrated in a map of FIG. 21, the reliability level gain may be set to continuously change from 1 to 0 in response to a change of the reliability level from 100% corresponding to a maximum value to 0%, Alternatively, as illustrated in a map of FIG. 22, a value of the reliability level gain may change stepwise from 1 to 0 at a certain value of the reliability level. In the former case, the suspension velocity Vsr gradually approaches 0 as the reliability level decreases. Thus, it is possible to obtain an effect that a signal of the suspension velocity Vsr input to the control device C fades out, and to avoid a rapid change in value. In the latter case, for example, in the case of performing a control operation by high selection using the control device C to obtain a target damping force of the damper D from vibration information other than the suspension velocity Vsr, and set a maximum value among a plurality of target damping forces to a final target damping force, it is possible to obtain an effect that a control operation using the suspension velocity Vsr having a decreased reliability level by the control device C may be immediately suspended. In the latter case, an effect that the presence/absence of a reliability level is determined is obtained. Thus, when the presence/absence of the reliability level is determined by the determination unit 8, the determination unit 8 may output a value of 1 or 0, and the reliability level gain multiplier 9 may multiply an output of the determination unit 8 by the suspension velocity Vsr without change.

In the above description, a reliability level is obtained by the determination unit 8 by focusing on whether a suspension velocity Vsr having high reliability may not be obtained without the rear wheel Wr passing the road surface r1 passed by the front wheel Wf, and whether a suspension velocity Vsr having high reliability may not be obtained by acceleration/deceleration even when the rear wheel Wr passes the road surface r1 passed by the front wheel Wf. Aside therefrom, the rear wheel unsprung velocity Vwr may not be accurately estimated due to a storage capacity of the storage unit 5.

As the velocity Va of the vehicle A decreases, a time from when the front wheel Wf passes the road surface r1 until the rear wheel Wr arrives at the road surface r1 increases. Meanwhile, as described above, the front wheel unsprung velocity Vwf is periodically detected at the sampling period Ts determined in advance. The fact that it takes time means that the number of data items of the front wheel unsprung velocity Vwf detected from when the front wheel Wf passes the road surface r1 until the rear wheel Wr arrives at the road surface r1 increases.

In a state in which the number of data items of the front wheel unsprung velocity Vwf sampled from when the front wheel Wf passes the road surface r1 until the rear wheel Wr arrives at the road surface r1 exceeds the number of data items of the front wheel unsprung velocity Vwf that maybe stored in the storage unit 5, a value of the front wheel unsprung velocity Vwf to be referred to at the time when the rear wheel Wr arrives at the road surface r1 and the rear wheel unsprung velocity Vwr is estimated is replaced with data corresponding to a case in which the front wheel Wf passes a different, road surface from the road surface r1. Thus, the rear wheel unsprung velocity Vwr may be not accurately estimated.

In this regard, the estimation suspension determination unit 15 is provided in the suspension vibration information estimation device E of the present embodiment. A velocity threshold value is provided, and the estimation suspension determination unit 15 multiplies 0 by the suspension velocity Vsr serving as suspension vibration information at a latter stage of the reliability level gain multiplier 9 when the velocity Va is lower than the velocity threshold value, and multiplies 1 by the suspension velocity Vsr to output 1 multiplied by the suspension velocity Vsr when the velocity Va is greater than or equal to the velocity threshold value. In the case of this embodiment, this output corresponds to a final suspension velocity Vsr obtained by the suspension vibration information estimation device E. In the above description, upon determining a reliability level in the determination unit 8, when the steering angle θ of the steering wheel Sw corresponding to the case (1) is large, the reliability level is decreased. However, in general, the steering angle θ of the steering wheel Sw is large when the velocity Va of the vehicle A is low. Thus, only determination by the estimation suspension determination unit 15 may be performed instead of determination of a reliability level based on the steering angle θ in the determination unit 8. In addition, a velocity threshold value Vref may be determined using the number N of data items, the wheel base length L, and the sampling period Ts. In addition, the estimation suspension determination unit 15 may be omitted in a case where there is no problem even when the number of data items that may be stored in the storage unit 5 is large, and the velocity Va is low.

Hereinbefore, a description has been given of each unit of the suspension vibration information estimation device E. A description will be given of a process for obtaining suspension vibration information by the suspension vibration information estimation device E. This process corresponds to a process of obtaining respective suspension velocities of right and left rear wheels Wr disposed on rear sides of respective right and left front wheels Wf of a four-wheeled vehicle from front wheel unsprung vibration information of the front wheels Wf.

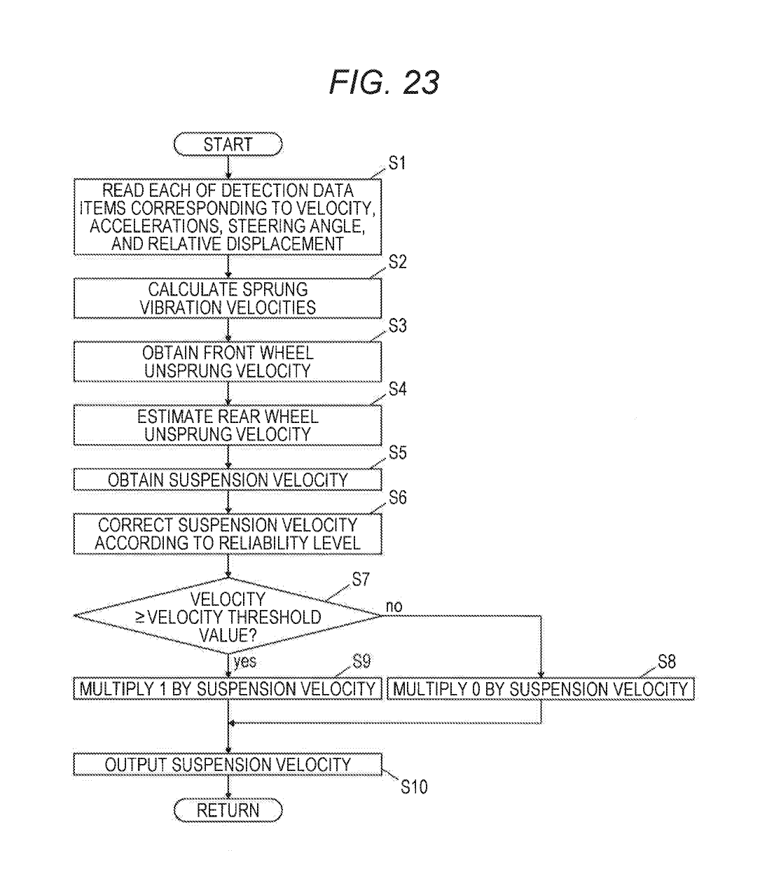

As illustrated in FIG. 23, the suspension vibration information estimation device E reads each of detection data items corresponding to the velocity Va detected by the velocity sensor 14, the accelerations detected by the acceleration sensors G1, G2, and G3, the steering angle θ detected by the steering angle sensor 30, and the relative displacement between the vehicle body B and the front wheel Wf detected by the stroke sensor H (step S1).

Subsequently, the suspension vibration information estimation device E calculates sprung velocities Vbf and Vbr as front and rear sprung vibration information of the vehicle A from the accelerations detected by the acceleration sensors G1, G2, and G3 (step S2). In addition, in processing of step S2, an operation of filtering the front wheel sprung velocity Vbf using the first integration low pass filter 10 and the first low frequency removal high pass filter 11, and an operation of filtering the rear wheel sprung velocity Vbr using the second integration low pass filter 20 and the second low frequency removal high pass filter 21 are performed.

Subsequently, the suspension vibration information estimation device E obtains the front wheel unsprung velocity Vwf as front wheel unsprung vibration information (step S3). Specifically, the suspension vibration information estimation device E obtains the suspension velocity Vsf by differentiating vertical relative displacement between the vehicle body B and the front wheel Wf detected by the stroke sensor H. Further, the suspension vibration information estimation device E adds the suspension velocity Vsf and the front wheel sprung velocity Vbf obtained in step S2 to obtain the front wheel unsprung velocity Vwf for each of the two right and left front wheels Wf of the vehicle A. In processing of step S3, an operation of filtering the suspension velocity Vsf using the differentiation high pass filter 12 and the high frequency removal low pass filter 13 is performed.

Then, the suspension vibration information estimation device E predicts that the rear wheel Wr will pass the road surface r1 passed by the front wheel Wf, and estimates that the front wheel unsprung velocity Vwf corresponding to a case in which the front wheel Wf present in front of the rear wheel Wr passes the road surface r1 is the rear wheel unsprung velocity Vwr for each of the right and left rear wheels Wr of the vehicle A (step S4). This estimation process corresponds to processing from step S21 to step S40 described above. Instead of the processing from step S21 to step S40 described above, it is possible to perform an operation of obtaining a time T required for the rear wheel Wr to arrive at the road surface r1 passed by the front wheel Wf based on the velocity Va and the wheel base length L, and setting the front wheel unsprung velocity Vwf stored in the storage unit 5 the time T ago to the rear wheel unsprung velocity Vwr.

Further, the suspension vibration information estimation device E obtains suspension velocities Vsr of the right and left rear wheels Wr by subtracting rear wheel sprung velocities Vbr immediately above the respective rear wheels Wr corresponding to the right and left rear wheels Wr from the rear wheel unsprung velocities Vwr of the right and left rear wheels Wr obtained in step S4 (step S5). In processing of step S5, when an error that may not be overlooked occurs between the obtained suspension velocity Vsr and the actual suspension velocity due to an influence of the coupled vibration component and the lever ratio described above, an operation of multiplying a compensation gain resulting from the compensation gain multiplier 6 by the suspension velocity Vsr is performed. In addition, when a phase shift that may not be overlooked occurs between the suspension velocity Vsr and the actual suspension velocity, an operation of filtering the suspension velocity Vsr using the phase compensation filter 7 to conform a phase to a phase of the actual suspension velocity is performed. Processing by the compensation gain multiplier 6 and processing by the phase compensation filter 7 may be omitted when the processing is unnecessary.

Subsequently, the suspension vibration information estimation device E obtains a reliability level of the obtained suspension velocity Vsr, and multiplies a reliability level gain by the suspension velocity Vsr according to the reliability level to correct the suspension velocity Vsr (step S6). This process is a process performed by the determination unit 8 described above.

Further, the suspension vibration information estimation device E determines whether the velocity Va is greater than or equal to a velocity threshold value with respect to the suspension velocity Vsr after processing in step S6, and multiplies 0 by the suspension velocity Vsr when the velocity Va is lower than the velocity threshold value and multiplies 1 by the suspension velocity Vsr when the velocity Va is greater than or equal to the velocity threshold value to output the multiplied value (step S7 to S10). The suspension velocity Vsr may be set to 0 when the velocity Va is lower than the velocity threshold value, and the suspension velocity Vsr may be output without change when the velocity Va is greater than or equal to the velocity threshold value. The suspension vibration information estimation device E repeatedly performs the above-described series of processes, obtains the suspension velocity Vsr for each control period, and continuously outputs the obtained suspension velocity Vsr to the control device C.

In the case of this embodiment, although not illustrated, specifically, for example, the suspension vibration information estimation device E may include, as hardware resources, an A/D converter for fetching signals output by the velocity sensor 14, the acceleration sensors G1, G2, and G3, the steering angle sensor 30, and the stroke sensor H, a storage unit such as a read only memory (ROM) that stores a program used for a process which is necessary for detection of a vibration level and calculation of a current value I, an operational unit such as a central processing unit (CPU) that executes a process based on the program, and a storage unit such as a random access memory RAM) that provides a storage area to the CPU. Each unit of the front wheel unsprung vibration information detector 1, the rear wheel sprung vibration information detector 2, the rear wheel unsprung vibration information estimator 3, the suspension vibration information estimator 4, the storage unit 5, the compensation gain multiplier 6, the phase compensation filter 7, the determination unit 8, the reliability level gain multiplier 9, and the estimation suspension determination unit 15 described above of the suspension vibration information estimation device E may be configured by the CPU executing the program, thereby implementing the above-described processes.

Hereinbefore, according to the suspension vibration information estimation device E, the suspension vibration information on the rear wheel Wr side in the vehicle A is obtained based on the rear wheel unsprung vibration information and the rear wheel sprung vibration information, and the suspension vibration information is estimated by taking the vibration state of the vehicle body B on the rear wheel side into consideration. Therefore, according to the suspension vibration information estimation device E of the present invention, it is possible to accurately estimate the suspension vibration information on the rear wheel Wr side.

Further, in the suspension vibration information estimation device E, the suspension vibration information on the rear wheel Wr side may be obtained without using a sensor that detects a quantity of state such as acceleration or stroke displacement on the rear wheel Wr side, and thus it is possible to reduce cost of the device.

In addition, specifically, the rear wheel unsprung vibration information estimator 3 estimates the rear wheel unsprung vibration information at the time when the rear wheel Wr passes the road surface r1 based on the velocity information, the wheel base. length L, and the front wheel unsprung vibration information acquired when the front wheel Wf of the vehicle A passes the road surface r1 on the assumption that the rear wheel Wr of the vehicle A passes the same road surface r1 as the road surface r1 passed by the front wheel Wf of the vehicle A, and thus may accurately estimate the rear wheel unsprung vibration information. In addition, since the suspension vibration information estimator 4 estimates the suspension vibration information based on the rear wheel unsprung vibration information at the time when the rear wheel Wr passes the road surface r1 and the rear wheel sprung vibration information at the time when the rear wheel Wr passes the road surface r1, the suspension vibration information on the rear wheel Wr side may be accurately estimated in consideration of the vibration state of the vehicle body B on the rear wheel side that changes in real time.

According to the suspension vibration information estimation device E, since the suspension vibration information is used as the damper velocity of the damper D interposed between the rear wheel Wr and the vehicle body B of the vehicle A, it is possible to provide information suitable for the control device C that controls the damping force of the damper D.

Further, in the suspension vibration information estimation device E of the present embodiment, the front wheel unsprung vibration information detector 1 includes the differentiation high pass filter 12 that obtains the front wheel unsprung velocity Vwf serving as the front wheel unsprung vibration information using the relative displacement between the front wheel Wf and the vehicle body B and the front wheel sprung acceleration, and filters the relative displacement, the high frequency removal low pass filter 13 that removes a high frequency component from the relative displacement, the first integration low pass filter 10 that integrates the front wheel sprung acceleration, and the first low frequency removal high pass filter 11 that removes a low frequency component from the front wheel sprung acceleration. In this way, both information items of the relative displacement and the front wheel sprung acceleration are processed by the high pass filter and the low pass filter. Thus, sprung vibration components included in the both information items after processing are easily conformed to each other in the practical area, and it is possible to improve accuracy of the obtained front wheel unsprung velocity Vwf. In addition, when the characteristic obtained by synthesizing the characteristics of the first integration low pass filter 10 and the first low frequency removal high pass filter 11 is conformed to the characteristic obtained by synthesizing the characteristics of the differentiation high pass filter 12 and the high frequency removal low pass filter 13, it is possible to conform gains of the front wheel sprung velocity Vbf and the suspension velocity Vsf to each other and mitigate a phase shift therebetween, and it is possible to accurately detect the front wheel unsprung velocity Vwf by effectively removing the sprung resonance frequency component from the obtained front wheel unsprung velocity Vwf.

Furthermore, in the suspension vibration information estimation device E of the present embodiment, the rear wheel sprung vibration information detector 2 includes the second integration low pass filter 20 that sets the rear wheel sprung vibration information to the rear wheel sprung velocity Vbr of the vehicle A, obtains the rear wheel sprung velocity Vbr using vertical acceleration on the rear wheel side of the vehicle body B, that is, rear wheel sprung acceleration, and integrates the acceleration, and the second low frequency removal high pass filter 21 that removes a low frequency component from the acceleration. In addition, a characteristic obtained by synthesizing characteristics of the differentiation high pass filter 12 and the high frequency removal low pass filter 13, a characteristic obtained by synthesizing characteristics of the first integration low pass filter 10 and the first low frequency removal high pass filter 11, and a characteristic obtained by synthesizing characteristics of the second integration low pass filter 20 and the second low frequency removal high pass filter 21 are equalized. For this reason, it is possible to conform gain characteristics of the rear wheel sprung velocity Vbr and the rear wheel unsprung velocity Vwr to each other and mitigate a phase shift therebetween, and it is possible to increase a conformity degree of the actual suspension velocity and the suspension velocity Vsr serving as obtained suspension vibration information.

Since the suspension vibration information estimation device E of the present embodiment includes the phase compensation filter 7 that compensates for a phase such that a phase of suspension vibration information approaches a phase of actual suspension vibration information, it is possible to obtain more accurate suspension vibration information.

In addition, in the suspension vibration information estimation device E of the present embodiment, a reliability level at which the obtained suspension vibration information is identical to the actual suspension vibration information is determined by the determination unit 8. For this reason, when the reliability level is low, a value of the suspension vibration information is set to 0, thereby restricting use of the information in an external device. In addition, when the reliability level is output as a signal to the external device, it is possible to provide a material for determining whether the obtained suspension vibration information may be used in the external device that uses the suspension vibration information. Further, when the determination unit 8 determines that a reliability level of the suspension vibration information is low, a reliability level gain multiplied by the suspension vibration information may be decreased. In this way, when reliability is low, at the time of outputting the suspension vibration information as a signal to the external device in response to a decrease in reliability, the signal may be faded out in association with the decrease in reliability.

Further, in the suspension vibration information estimation device E of the present embodiment, the determination unit 8 determines the reliability level of the suspension vibration information based on a ratio of velocity information at the time when the front wheel Wf passes the read surface r1 to velocity information at the time when the rear wheel Wr is presumed to pass the same road surface r1. Thus, it is possible to identify a state in which the vehicle A may not accurately estimate the rear wheel unsprung vibration information due to rapid acceleration/deceleration. In such a case, the reliability level may be decreased. In addition, when the determination unit θ determines the reliability level of the suspension vibration information based on steering angle information of the wheel Wf, it is possible to identify a state in which the rear wheel Wr may not pass the road surface r1 passed by the front wheel Wf. In such a case, the reliability level may foe decreased.

In the suspension vibration information estimation device E of the present embodiment, when the velocity Va of the vehicle A is lower than the velocity threshold value Vref, the suspension vibration information is not estimated. Thus, estimation of the suspension vibration information may be suspended when a value of the front wheel unsprung velocity Vwf to be referred to at the time when the rear wheel Wr arrives at the road surface r1 and the rear wheel unsprung velocity Vwr is estimated is replaced with data corresponding to a case in which the front wheel Wf passes a different road surface from the road surface r1. Therefore, when the estimated suspension vibration information is output to the control device, the external device does not perform a control operation based on erroneous information. Further, it is possible to replace a function of the determination unit 8 that reduces a reliability level when the steering angle θ is large.

In the above description, the suspension vibration information on the rear wheel Wr side described above is used as the suspension velocity Vsr on the rear wheel Wr side. However, the suspension vibration information may be used as information that allows identification of suspension vibration on the rear wheel Wr such as suspension displacement, suspension acceleration, or a suspension acceleration change rate. The front wheel unsprung vibration information may correspond to information that allows identification of vibration of the front wheel Wf such as displacement, velocity, acceleration, or a suspension acceleration change rate in the vertical direction of the front wheel Wf. This description is similarly applied to the rear wheel unsprung vibration information and the rear wheel sprung vibration information. For example, in a case where the suspension vibration information is set to suspension displacement, information is easily handled when all the front wheel unsprung vibration information, the rear wheel unsprung vibration information, and the rear wheel sprung vibration information are set to displacements.

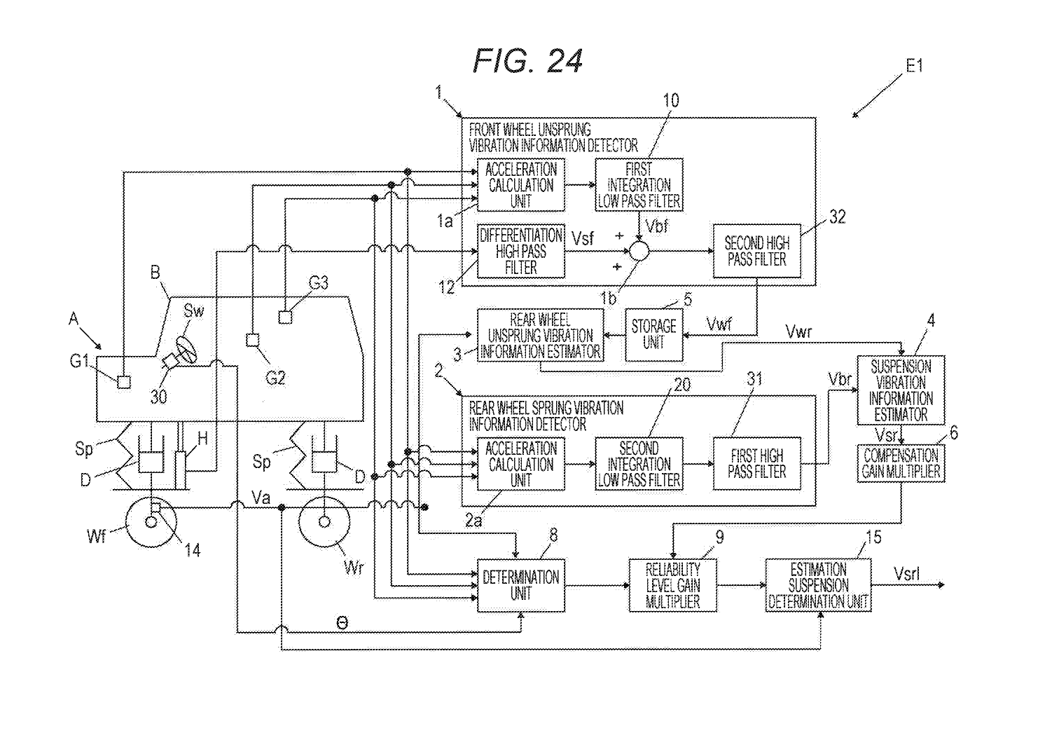

Next, a description will be given of a suspension vibration information estimation device E1 according to a second embodiment. As illustrated in FIG. 24, the suspension vibration information estimation device E1 includes a first high pass filter 31 whose cutoff frequency is in a lower frequency range than a sprung resonance frequency and which removes a component in a low frequency range from information in a process of obtaining rear wheel sprung vibration information or rear wheel sprung vibration information, and a second high pass filter 32 whose cutoff frequency is in a lower frequency range than the sprung resonance frequency, whose gain characteristic and phase characteristic in the sprung resonance frequency are the same as characteristics of the first high pass filter 31, and which removes a component in a low frequency range from the front wheel unsprung vibration information or information in a process of obtaining the front wheel unsprung vibration information or the front wheel unsprung vibration information, and is different from the suspension vibration information estimation device E of the first embodiment in that the suspension vibration information estimation device E1 does not include the first low frequency removal high pass filter 11, the high frequency removal low pass filter 13, and the second low frequency removal high pass filter 21.

For this reason, in this embodiment, a rear wheel sprung vibration information detector 2 does not include the second low frequency removal high pass filter 21, and the first high pass filter 31 is separately provided. The first high pass filter 31 may process a signal generated in a process from when vertical acceleration immediately above the rear wheel Wr is obtained from vertical accelerations of the vehicle body B detected by the three acceleration sensors G1, G2, and G3 until a rear wheel sprung velocity Vbr is obtained, or may process the rear wheel sprung velocity Vbr. Further, the cutoff frequency of the first high pass filter 31 is in a lower frequency range than the sprung resonance frequency, and an integral drift component is removed from the obtained rear wheel sprung velocity Vbr.

The second high pass filter 32 is provided at a latter stage of an adder 1b in FIG. 24, and may process any one of information generated in a process in which the front wheel unsprung vibration information detector 1 obtains a front wheel unsprung velocity Vwf from a front wheel sprung velocity Vbf and a suspension velocity Vsf, the front wheel unsprung velocity Vwf, or a rear wheel unsprung velocity Vwr obtained from, the front wheel unsprung velocity Vwf by a rear wheel unsprung vibration information estimator 3. Further, the second high pass filter 32 has the same gain characteristic and phase characteristic in the sprung resonance frequency as those of the first high pass filter 31, and removes a low frequency component from information before processing.

In this way, in the suspension vibration information estimation device E1 of the second embodiment, the rear wheel sprung velocity Vbr is obtained by integrating the vertical acceleration immediately above the rear wheel Wr, and the integral drift component is removed from the rear wheel sprung velocity Vbr through processing by the first high pass filter 31. Then, the suspension vibration information estimator 4 obtains a suspension velocity Vsr on the rear wheel side from the rear wheel unsprung velocity Vwr and the rear wheel sprung velocity Vbr. Here, since information until the rear wheel unsprung velocity Vwr is obtained from the front wheel unsprung velocity Vwf is processed by the second high pass filter 32 having the same gain characteristic and phase characteristic in the sprung resonance frequency as those of the first nigh pass filter 31, a phase shift between sprung resonance frequency components of the rear wheel unsprung velocity Vwr and the rear wheel sprung velocity Vbr is mitigated. Therefore, the suspension velocity Vsr may be accurately obtained in the suspension vibration information estimation device E1 of the second embodiment.

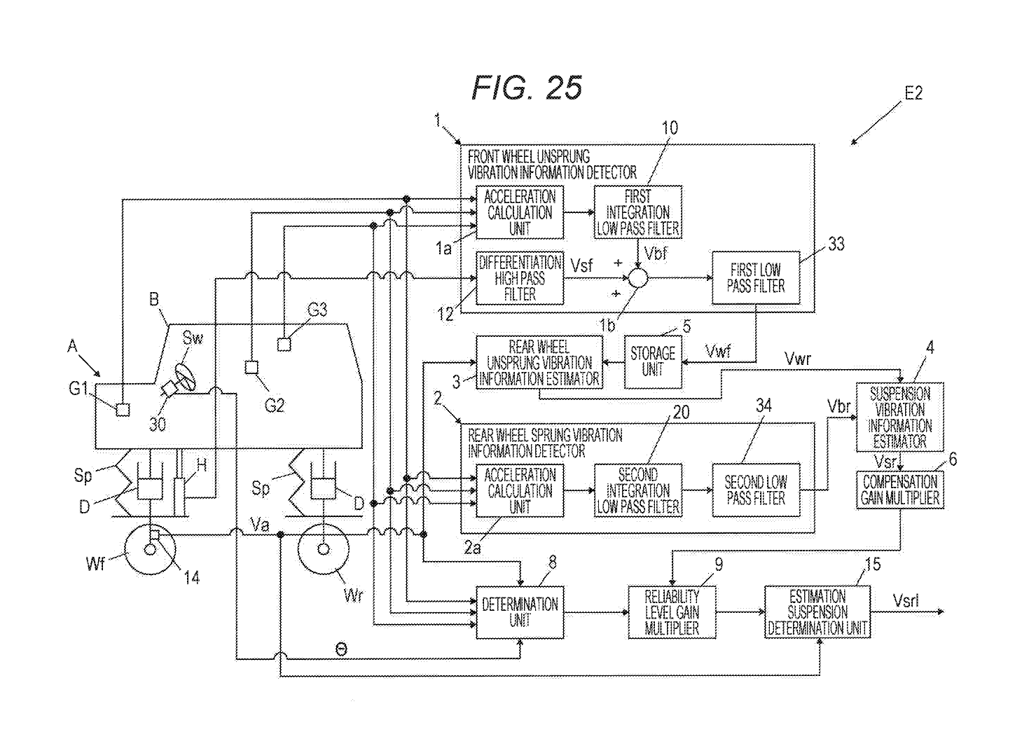

Next, a description will be given of a suspension vibration information estimation device E2 according to a third embodiment. As illustrated in FIG. 25, the suspension vibration information estimation device E2 includes a first low pass filter 33 whose cutoff frequency is in a higher frequency range than an unsprung resonance frequency and which removes a component in a high frequency range from in formation in a process of obtaining the front wheel unsprung vibration information or the front wheel unsprung vibration information, or information obtained from the front wheel unsprung vibration information, and a second low pass filter 34 whose cutoff frequency is in a higher frequency range than the unsprung resonance frequency, whose gain characteristic and phase characteristic in the unsprung resonance frequency are the same as characteristics of the first low pass filter 33, and which removes a component in a high frequency range from rear wheel sprung vibration information or information in a process of obtaining the rear wheel sprung vibration information, and is different from the suspension vibration information estimation device E of the first embodiment in that the suspension vibration information estimation device E2 does not include the first low frequency removal high pass filter 11, the high frequency removal low pass filter 13, and the second low frequency removal high pass filter 21,

Specifically, the first low pass filter 33 processes information generated in a process in which a front wheel unsprung vibration information detector obtains a front wheel unsprung velocity Vwf from a front wheel sprung velocity Vbf and a suspension velocity Vsf, the front wheel unsprung velocity Vwf, or a rear wheel unsprung velocity Vwr obtained from the front wheel unsprung velocity Vwf by a rear wheel unsprung vibration information estimator 3. Further, the cutoff frequency of the first low pass filter 33 is in a higher frequency range than the unsprung resonance frequency, and a differential noise component superimposed on a rear wheel sprung velocity Vbr is removed when the suspension velocity Vsf is obtained by differentiating relative displacement detected by the stroke sensor H.

In this embodiment, a rear wheel sprung vibration information detector 2 does not include the second low frequency removal high pass filter 21, and the second low pass filter 34 is separately provided. The second low pass filter 34 may process a signal generated in a process from when vertical acceleration immediately above the rear wheel Wr is obtained from vertical accelerations of the vehicle body B detected by the three acceleration sensors G1, G2, and G3 until a rear wheel sprung velocity Vbr is obtained, or may process the rear wheel, sprung velocity Vbr. Further, in the second low pass filter 34, the cutoff frequency is in a higher frequency range than the sprung resonance frequency, a gain characteristic and a phase characteristic in the unsprung resonance frequency are the same as those of the first low pass filter 33, and a low frequency component is removed from information before processing.

In this way, in the suspension vibration information estimation device E2 of the third embodiment, a front wheel unsprung velocity Vwf is obtained using a suspension velocity Vsf which is obtained by differentiating relative displacement between the front wheel Wf and the vehicle body B, a rear wheel unsprung velocity Vwr is obtained from the front wheel unsprung velocity Vwf, and a differential noise component is removed from the rear wheel sprung velocity Vbr through processing by the first low pass filter 33. Then, a suspension vibration information estimator 4 obtains a suspension velocity Vsr on the rear wheel side from the rear wheel unsprung velocity Vwr and the rear wheel sprung velocity Vbr. Here, since information until the rear wheel sprung velocity Vbr is obtained is processed by the second low pass filter 34 having the same gain characteristic and phase characteristic in the unsprung resonance frequency as those of the first low pass filter 33, a phase shift between unsprung resonance frequency components of the rear wheel unsprung velocity Vwr and the rear wheel sprung velocity Vbr is mitigated. Therefore, the suspension velocity Vsr may be accurately obtained in the suspension vibration information estimation device E2 of the third embodiment.

Hereinbefore, description of the embodiments of the present invention has been completed. However, the scope of the present invention is not limited to illustrated or described details.

For example, the suspension vibration information estimation device of the present invention may be used to control a damper or an actuator interposed between a vehicle body and a wheel of a vehicle.

This application is based upon and claims the benefit of priority from Japanese Patent Application No. 2015-073235, filed on Mar. 31, 2015, the entire contents of which, are incorporated herein by reference.

1. A suspension vibration information estimation device comprising:
a front wheel unsprung vibration information detector that obtains front wheel unsprung vibration information corresponding to unsprung vibration information on a side of a front wheel of a vehicle;
a rear wheel sprung vibration information detector that obtains rear wheel sprung vibration information corresponding to sprung vibration information on a side of a rear wheel of the vehicle;
a rear wheel unsprung vibration information estimator that estimates rear wheel unsprung vibration information on the rear wheel side of the vehicle based on the front wheel unsprung vibration information, velocity information in a front-rear direction of the vehicle, and a wheel base length of the vehicle; and
a suspension vibration information estimator that obtains suspension vibration information on the rear wheel side of the vehicle based on the rear wheel unsprung vibration information and the rear wheel sprung vibration information.

2. The suspension vibration information estimation device according to claim 1,
wherein the rear wheel unsprung vibration information estimator estimates the rear wheel unsprung vibration information at a time when the rear wheel passes a road surface passed by the front wheel of the vehicle based on the velocity information, the wheel base length, and the front wheel unsprung vibration information acquired when the front wheel of the vehicle passes the road surface on an assumption that the rear wheel of the vehicle passes the same road surface as the road surface passed by the front wheel of the vehicle, and
the suspension vibration information estimator estimates the suspension vibration information based on the rear wheel unsprung vibration information at the time when the rear wheel passes the road surface and the rear wheel sprung vibration information at the time when the rear wheel passes the road surface.

3. The suspension vibration information estimation device according to claim 1, wherein the suspension vibration information corresponds to a damper velocity of a damper interposed between a vehicle body and the rear wheel of the vehicle.

4. The suspension vibration information estimation device according to claim 1, further comprising:
a first high pass filter whose cutoff frequency is in a lower frequency range than a sprung resonance frequency and which removes a component in a low frequency range from the rear wheel sprung vibration information or information in a process of obtaining the rear wheel sprung vibration information; and
a second high pass filter whose cutoff frequency is in a lower frequency range than the sprung resonance frequency, whose gain characteristic and phase characteristic in the sprung resonance frequency are the same as characteristics of the first high pass filter, and which removes a component in a low frequency range from the front wheel unsprung vibration information or information in a process of obtaining the front wheel unsprung vibration information.

5. The suspension vibration information estimation device according to claim 1, further comprising:
a first low pass filter whose cutoff frequency is in a higher frequency range than an unsprung resonance frequency and which removes a component in a high frequency range from the front wheel unsprung vibration information, information in a process of obtaining the front wheel unsprung vibration information, or information obtained from the front wheel unsprung vibration information; and
a second low pass filter whose cutoff frequency is in a higher frequency range than the unsprung resonance frequency, whose gain characteristic and phase characteristic in the unsprung resonance frequency are the same as characteristics of the first low pass filter, and which removes a component in a high frequency range from the rear wheel sprung vibration information or information in a process of obtaining the rear wheel sprung vibration information.

6. The suspension vibration information estimation device according to claim 1, wherein the front wheel unsprung vibration information detector
uses the front wheel unsprung vibration information as a front wheel unsprung velocity, obtains the front wheel unsprung velocity using relative displacement between the front wheel and a vehicle body of the vehicle and front wheel sprung acceleration corresponding to vertical acceleration on a front side of the vehicle body, and includes
a differentiation high pass filter that differentiates the relative displacement,
a high frequency removal low pass filter that removes a high frequency component from the relative displacement,
a first integration low pass filter that integrates the front wheel sprung acceleration, and
a first low frequency removal high pass filter that removes a low frequency component from the front wheel sprung acceleration.

7. The suspension vibration information estimation device according to claim 6,
wherein the rear wheel sprung vibration information detector
uses the rear wheel sprung vibration information as a rear wheel sprung velocity of the vehicle, obtains the rear wheel sprung velocity using rear wheel sprung acceleration corresponding to vertical acceleration on the rear wheel side of the vehicle body of the vehicle, and includes
a second integration low pass filter that integrates the rear wheel sprung acceleration, and
a second low frequency removal high pass filter that removes a low frequency component from the rear wheel sprung acceleration, and
a characteristic obtaining by synthesizing the differentiation high pass filter and the high frequency removal low pass filter, a characteristic obtaining by synthesizing the first integration low pass filter and the first low frequency removal high pass filter, and a characteristic obtaining by synthesizing the second integration low pass filter and the second low frequency removal high pass filter are identical to one another.

8. The suspension vibration information estimation device according to claim 7, further comprising
a phase compensation filter that compensates for a phase such that a phase of the suspension vibration information approaches a phase of actual suspension vibration information.

9. The suspension vibration information estimation device according to claim 1, further comprising
a determination unit that determines a reliability level of the suspension vibration information.

10. The suspension vibration information estimation device according to claim 9, wherein a reliability level gain multiplied by the suspension vibration information is decreased when the determination unit determines that the reliability level of the suspension vibration information is low.

11. The suspension vibration information estimation device according to claim 9, wherein the determination unit determines the reliability level of the suspension vibration information based on a ratio of velocity information of the vehicle at a time when the front wheel passes the road surface to velocity information of the vehicle at a time when the rear wheel is presumed to pass the same road surface.

12. The suspension vibration information estimation device according to claim 9, wherein the determination unit determines the reliability level of the suspension vibration information based on steering angle information of the wheel.

13. The suspension vibration information estimation device according to claim 1, wherein the suspension vibration information is not estimated when a velocity of the vehicle is lower than a velocity threshold value.
